(19) United States
(12) Patent Application Publication
(10) Pub. No.: US 2010/0182662 A1
(43) Pub. Date: Jul. 22, 2010

(54) RECORDING/REPRODUCTION METHOD AND HOLOGRAM RECORDING MEDIUM

(75) Inventors: Akio YAMAKAWA, Tokyo (JP); Kenji Tanaka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Sony Corporation, Tokyo (JP)

(21) Appl. No.: 12/648,635

(22) Filed: Dec. 29, 2009

(30) Foreign Application Priority Data
Jan. 16, 2009 (JP) 2009-007845

(51) Int. Cl. G03H 1/02

(52) U.S. Cl. 359/3

(57) ABSTRACT

A recording/reproduction method of performing recording/reproduction of a hologram by illuminating a hologram recording medium, which has a recording layer in which information is recorded by interference fringes between signal light and reference light, with the signal light and/or the reference light as recording/reproduction light through an objective lens includes the step of: setting a focal position of the recording/reproduction light such that a distance from a surface of the hologram recording medium to the focal position of the recording/reproduction light is larger than a distance from the surface to a lower-layer-side surface of the recording layer and illuminating the hologram recording medium including an angle-selective reflective layer, which is formed below the recording layer and has a selective light reflection/transmission characteristic depending on a light incidence angle, with the recording/reproduction light the focal position of which has been set.

### BACKGROUND OF THE INVENTION

1. Field of the Invention

The present invention relates to a reproduction apparatus and a reproduction method of performing reproduction on a hologram recording medium in which information recording is performed by a hologram formed by interference fringes between signal light and reference light.

2. Description of the Related Art

For example, as disclosed in Japanese Unexamined Patent Application Publication No. 2007-79438, a hologram recording/reproduction method of performing data recording by forming a hologram is known. In this hologram recording/reproduction method, at the time of recording, signal light subjected to spatial light modulation (intensity modulation) corresponding to recording data and reference light with a predetermined light intensity pattern set beforehand are generated and the signal light and the reference light illuminate a hologram recording medium to form a hologram on the hologram medium, thereby performing the data recording.

In addition, at the time of reproduction, the reference light illuminates the recording medium. In this way, by illuminating a hologram, which is formed by illumination of the signal light and the reference light at the time of recording, with the same reference light (having the same intensity pattern as that at the time of recording) as that at the time of recording, diffracted light corresponding to the recorded signal light component can be obtained. That is, a reproduced image (reproduced signal light) corresponding to the recording data is obtained as described above. The recorded data is reproduced by detecting the reproduced light obtained as described above with an image sensor, such as a CCD (Charge Coupled Device) sensor or a CMOS (Complementary Metal Oxide Semiconductor) sensor.

In addition, as such a hologram recording/reproduction method, a so-called coaxial method is used in which reference light and signal light are disposed on the same optical axis to illuminate a hologram recording medium through a common objective lens.

FIGS. 21, 22A, and 22B are diagrams illustrating hologram recording/reproduction using the coaxial method. FIG. 21 schematically shows the recording method, and FIGS. 22A and 22B schematically show the reproduction method.

Moreover, FIGS. 21, 22A, and 22B show the case where a reflective hologram recording medium 100 with a reflective film is used.

First, in the hologram recording/reproduction system, an SLM (spatial light modulator) 101 is provided to generate signal light and reference light at the time of recording and reference light at the time of reproduction as shown in FIGS. 21, 22A, and 22B. As the SLM 101, an intensity modulator that performs light intensity modulation on the incident light in the pixel unit is provided. As the intensity modulator, for example, a liquid crystal panel may be used.

At the time of recording shown in FIG. 21, signal light with an intensity pattern corresponding to the recording data and reference light with a predetermined intensity pattern set beforehand are generated by intensity modulation of the SLM 101. In the coaxial method, the spatial light modulation is performed on incident light under the conditions in which the signal light and the reference light are disposed on the same optical axis as shown in FIG. 21. In this case, generally, the signal light is disposed at the inner side and the reference light is disposed at the outer side as shown in FIG. 21.

The signal light and the reference light generated by the SLM 101 illuminate the hologram recording medium 100 through an objective lens 102. As a result, a hologram which reflects the recording data is formed in the hologram recording medium 100 by the interference fringes between the signal light and the reference light. That is, recording of data is performed by the forming of the hologram.

On the other hand, at the time of reproduction, reference light is generated by the SLM 101 as shown in FIG. 22A (in this case, the intensity pattern of the reference light is the same as that at the time of recording). In addition, the reference light illuminates the hologram recording medium 100 through the objective lens 102.

By illuminating the hologram recording medium 100 with the reference light, diffracted light corresponding to the hologram formed in the hologram recording medium 100 is obtained and accordingly, a reproduced image based on the recorded data is obtained as shown in FIG. 22B. In this case, the reproduced image is guided, as reflected light from the hologram recording medium 100, to an image sensor 103 through the objective lens 100 as shown in FIG. 22B.

The image sensor 103 obtains a detection image regarding the reproduced image by receiving the reproduced image guided as described above in the pixel unit and acquiring an electric signal corresponding to the amount of received light for every pixel. The image signal detected as described above by the image sensor 103 becomes a read signal of the recorded data.

In addition, as also can be understood from the explanation of FIGS. 21, 22A, and 22B, the recording data is recorded/reproduced in the unit of signal light in the hologram recording/reproduction method. That is, in the hologram recording/reproduction method, one hologram (called a hologram page) which is formed by one-time interference between signal light and reference light is set as a minimum unit of recording/reproduction.

Here, the case is considered in which data is sequentially recorded in the unit of a hologram page in the hologram recording medium 100.

In the past optical disc system, such as a CD (Compact Disc) or a DVD (Digital Versatile Disc), a recording medium is made in a disc shape and the data is recorded by forming a mark while driving the recording medium so as to rotate. In this case, a guide groove (track) is formed in a spiral or concentric shape in the recording medium, and the data is recorded at the predetermined position on the recording medium by forming a mark while controlling the beam spot position so as to trace the track.

Also in the hologram recording/reproduction system, it is considered to adopt a method in which a track is formed in a spiral or concentric shape in the disc-shaped hologram recording medium 100 and a hologram is formed by sequentially illuminating the hologram recording medium 100, which is driven to rotate, with signal light and reference light so that a hologram page is formed along the track.

When the method of forming a hologram page at the position along a track as described above is adopted, it is necessary to perform control of the recording/reproduction position, such as tracking servo for tracing a beam spot on the track or control of access to a predetermined address.

In actual conditions, it is considered to perform separate illumination of laser light for exclusive use when controlling such a recording/reproduction position. That is, this is a method of performing separate illumination of laser light for recording/reproduction of a hologram (laser light for illumination of signal light and reference light: laser light for recording/reproduction) and laser light for controlling the recording/reproduction position of a hologram (laser light for position control).

In order to meet the method of performing separate illumination of the laser light for position control as described above, the hologram recording medium 100 actually has a structure shown in FIG. 23.

As shown in FIG. 23, in the hologram recording medium 100, a recording layer L4 in which a hologram is recorded and a position control information recording layer in which address information for position control and the like are recorded by the uneven structure on a substrate L3 are separately formed.

Specifically, a cover layer L1, a reflective layer L2, a substrate L3, a recording layer L4, a reflective layer L5, and a substrate L6 are formed in the hologram recording medium 100 in order from the upper layer. The reflective layer L5 formed below the recording layer L4 is provided so that, when the reference light using the laser light for recording/reproduction is illuminated at the time of reproduction and a reproduced image corresponding to a hologram recorded in the recording layer L4 is acquired, the reproduced image is returned to the apparatus side as reflected light.

In addition, a track for guiding the recording/reproduction position of a hologram in the recording layer L4 is formed in a spiral or concentric shape in the substrate L3. For example, the track is formed by performing information recording of the address information or the like using a pit sequence.

The reflective layer L2 formed on the substrate L3 is provided in order to obtain the reflected light regarding the information recorded in the substrate L3.

Here, in order to appropriately record/reproduce a hologram in the hologram recording medium 100 with the above-described sectional structure, laser light for hologram recording/reproduction, such as signal light or reference light, should be transmitted through the reflective layer L2 formed above the recording layer L4.

In consideration of this point, in the past hologram recording/reproduction system, laser light components with different wavelengths using laser light for recording/reproduction of a hologram and laser light for position control are illuminated. For example, purple-blue laser light with a wavelength λ of about 405 nm is used as the laser light for hologram recording/reproduction. On the other hand, as the laser light for position control, for example, red laser light with a wavelength λ of about 650 nm is used.

In addition, as the reflective layer L2 formed above the recording layer L4, a reflective layer with wavelength selectivity which transmits the purple-blue laser light for recording/reproduction and reflects the red laser light for position control is used.

By adopting such a configuration, the laser light for recording/reproduction is transmitted through the reflective layer L2 so that recording/reproduction of a hologram can be appropriately performed, and the laser light for position control is reflected by the reflective layer L2. As a result, the reflected light information for position control can be appropriately returned to the apparatus side.

FIG. 24 is a diagram illustrating the configuration of a recording/reproduction apparatus as an example in the related art, which performs recording/reproduction corresponding to the hologram recording medium 100 with the above-described structure, in a simple way (mainly, only for an optical system).

First, the recording/reproduction apparatus includes a first laser 1, a collimation lens 2, a polarization beam splitter 3, an SLM 4, a polarization beam splitter 5, a relay lens 6, an aperture 104, a relay lens 7, a dichroic mirror 8, a partial diffraction element 9, a ¼ wavelength plate 10, an objective lens 102, and an image sensor 103 which are provided as an optical system for illumination of the reference light and the signal light for recording/reproduction of a hologram.

The first laser 1 outputs, for example, the above-described purple-blue laser light with a wavelength λ of about 405 nm as laser light for recording/reproduction of a hologram. The laser light emitted from the first laser 1 is incident on the polarization beam splitter 3 through the collimation lens 2.

The polarization beam splitter 3 transmits one of linearly polarized light components, which are perpendicular to each other, of the incident laser light and reflects the other linearly polarized light component. In this case, the polarization beam splitter 3 is configured to transmit a p-polarized light component and reflect an s-polarized light component, for example.

Accordingly, only an s-polarized light component of the laser light incident on the polarization beam splitter 3 is reflected and guided to the SLM 4.

The SLM 4 includes a reflective liquid crystal element as an FLC (Ferroelectric Liquid Crystal), for example, and is configured to control the polarization direction of the incident light in the pixel unit.

The SLM 4 performs spatial light modulation by changing the polarization direction of the incident light by 90° according to a driving signal from a modulation control section 20 in the drawing for every pixel or without changing the polarization direction of the incident light. Specifically, the SLM 4 is configured to perform the polarization direction control according to a driving signal in the pixel unit such that an angle variation of the polarization direction is set to 90° for a pixel for which a driving signal is ON and an angle variation of the polarization direction is set to 0° for a pixel for which the driving signal is OFF.

As shown in FIG. 24, emitted light from the SLM 4 (light reflected by the SLM 4) is incident on the polarization beam splitter 3 again.

Here, in the recording/reproduction apparatus shown in FIG. 24, the spatial light intensity modulation (referred to as light intensity modulation or simply intensity modulation) in the pixel unit is performed using the polarization direction control in the pixel unit using the SLM 4 and the characteristic of selective transmission/reflection of the polarization beam splitter 3 according to the polarization direction of incident light.

FIGS. 25A and 25B show images of intensity modulation realized by the combination of the SLM 4 and the polarization beam splitter 3. FIG. 25A schematically shows a light beam state of light of an ON pixel, and FIG. 25B schematically shows a light beam state of light of an OFF pixel.

Since the polarization beam splitter 3 transmits p-polarized light and reflects s-polarized light as described above, the s-polarized light is incident on the SLM 4.

Under such an assumption, light (light of a pixel of driving signal ON) of a pixel the polarization direction of which has been changed by 90° by the SLM 4 is incident on the polarization beam splitter 3 as p-polarized light. Then, the light of the ON pixel in the SLM 4 is transmitted through the polarization beam splitter 3 and is guided toward the hologram recording medium 100 (FIG. 25A).

On the other hand, light of a pixel for which the driving signal is OFF and the polarization direction of which has not been changed is incident on the polarization beam splitter 3 as s-polarized light. That is, the light of the OFF pixel in the SLM 4 is reflected by the polarization beam splitter 3 so as not to be guided toward the hologram recording medium 100 (FIG. 25B).

In this way, an intensity modulating section which performs light intensity modulation in the pixel unit is formed by the combination of the polarization direction control type SLM 4 and the polarization beam splitter 3. By such an intensity modulating section, the signal light and the reference light are generated at the time of recording, and the reference light is generated at the time of reproduction.

The laser light for recording/reproduction which has been subjected to spatial light modulation by the intensity modulating section is incident on the polarization beam splitter 5. The polarization beam splitter 5 is also configured to transmit the p-polarized light and reflect the s-polarized light. Accordingly, the laser light (light transmitted through the polarization beam splitter 3) emitted from the intensity modulating section is transmitted through the polarization beam splitter 5.

The laser light transmitted through the polarization beam splitter 5 is incident on the relay lens system in which the relay lens 6, the aperture 104, and the relay lens 7 are disposed in this order. As shown in FIG. 24, the relay lens 6 makes the laser light beams, which have been transmitted through the polarization beam splitter 5, condensed at the predetermined focal position, and the relay lens 7 converts the laser light beams as diffused light after condensing into parallel light. The aperture 104 is provided at the focal position (Fourier plane: frequency plane) generated by the relay lens 6 and is configured to transmit only light within the predetermined range around the optical axis and to block the other light.

The size of a hologram page recorded in the hologram recording medium 100 is restricted by the aperture 104, so that the recording density (that is, data recording density) of a hologram can be improved.

The laser light transmitted through the relay lens system is incident on the dichroic mirror 8. The dichroic mirror 8 is configured to selectively reflect the light within a predetermined wavelength range. Specifically, in this case, the dichroic mirror 8 is configured to selectively reflect light in a wavelength range of the laser light for recording/reproduction with a wavelength λ of about 405 nm.

Accordingly, the laser light for recording/reproduction which has been incident through the relay lens system is incident on the dichroic mirror 8.

The laser light for recording/reproduction reflected by the dichroic mirror 8 is incident on the objective lens 102 through the partial diffraction element 9 and the ¼ wavelength plate 10.

The partial diffraction element 9 and the ¼ wavelength plate 10 are provided in order to prevent the reference light (reflected reference light) reflected by the hologram recording medium 100 at the time of reproduction from being guided to the image sensor 103 and becoming a noise against the reproduced light.

In addition, operations of the partial diffraction element 9 and ¼ wavelength plate 10 for suppressing the reflected reference light will be described later.

The objective lens 102 is held by a biaxial mechanism 12 shown in FIG. 24 so as to be movable in the focusing direction and the tracking direction. A position control section 19, which will be described later, controls an operation of the biaxial mechanism 12 for driving the objective lens 102, thereby controlling the spot position of the laser light.

The laser light for recording/reproduction illuminates the hologram recording medium 100 after being condensed by the objective lens 102.

Here, as described previously, at the time of recording, the signal light and the reference light are generated by intensity modulation using the intensity modulating section (SLM 4 and polarization beam splitter 3) and the signal light and the reference light illuminate the hologram recording medium 100 through the path described above. As a result, a hologram which reflects the recording data is formed in the recording layer L4 by the interference fringes between the signal light and the reference light and accordingly, the data recording is realized.

In addition, at the time of reproduction, only the reference light is generated by the intensity modulating section and illuminates the hologram recording medium 100 through the path described above. By such illumination of the reference light, a reproduced image corresponding to the hologram formed in the recording layer L4 can be obtained as reflected light from the reflective layer L5. This reproduced image is returned to the apparatus side through the objective lens 102.

Here, according to the previous operation of the intensity modulating section, the reference light (referred to as forward path reference light) that illuminates the hologram recording medium 100 at the time of reproduction is incident on the partial diffraction element 9 as p-polarized light. As also will be described later, since the partial diffraction element 9 is configured to transmit all light beams in the forward path, the forward path reference light based on the p polarization is transmitted through the 1/4 wavelength plate 10. The forward path reference light based on the p polarization transmitted through the ¼ wavelength plate 10 is converted into circularly polarized light in a predetermined rotation direction and illuminates the hologram recording medium 100.

The reference light that illuminates the hologram recording medium 100 is reflected by the reflective layer L5 and is guided to the objective lens 102 as reflected reference light (return path reference light). In this case, the rotation direction of circularly polarized light of the return path reference light is changed to an opposite rotation direction to the predetermined rotation direction by reflection from the reflective layer L5. As a result, the return path reference light is transmitted through the ¼ wavelength plate 10 and is converted into s-polarized light.

Here, an operation of the partial diffraction element 9 and the ¼ wavelength plate 10 for suppressing the reflected reference light after the above-described polarization state transition will be described.

The partial diffraction element 9 is obtained by forming a polarization-selective diffraction element which has a selective diffraction characteristic (one linearly polarized light component is diffracted and the other linearly polarized light component is transmitted) according to a polarization state of linearly polarized light, such as a liquid crystal diffraction element, in a region (region excluding a middle portion) on which the reference light is incident. Specifically, the polarization-selective diffraction element provided in the partial diffraction element 9 is configured to transmit p-polarized light and diffract s-polarized light. Accordingly, the reference light in the forward path is transmitted through the partial diffraction element 9, and only the reference light in the return path is diffracted (suppressed) by the partial diffraction element 9.

As a result, it is possible to prevent a situation where the reflected reference light as return path light is detected as a noise component against a reproduced image and accordingly, the S/N ratio is decreased.

In addition, for clarity, a region (region on which a reproduced image is incident) of the partial diffraction element 9 on which signal light is incident is formed to transmit both the forward path light and the return path light. For example, the region is formed of a transparent material or formed as a hole. Accordingly, the signal light at the time of recording and the reproduced image at the time of reproduction are transmitted through the partial diffraction element 9.

As also can be understood from the above description up to now, in the hologram recording/reproduction system, the reference light illuminates a recorded hologram and a reproduced image is acquired using the diffraction phenomenon. In this case, however, the diffraction efficiency is generally several percent or less than 1%. Accordingly, the reference light returned to the apparatus side as reflected light as described above has an extremely large intensity compared with the reproduced image. That is, the reference light as the reflected light becomes a noise component which is difficult to neglect in detection of the reproduced image.

For this reason, the reflected reference light is suppressed by the partial diffraction element 9 and the ¼ wavelength plate 10, so that the S/N ratio can be significantly improved.

The reproduced image acquired at the time of reproduction as described above is transmitted through the partial diffraction element 9. The reproduced image transmitted through the partial diffraction element 9 is reflected by the dichroic mirror 8 and is then incident on the polarization beam splitter 5 through the relay lens system (relay lens 7→aperture 104→relay lens 6) described above. As also can be understood from the above description up to now, since the reflected light from the hologram recording medium 100 is converted into s-polarized light through ¼ wavelength plate 10, the reproduced image incident on the polarization beam splitter 5 as described above is reflected by the polarization beam splitter 5 and is then incident on the image sensor 103.

Thus, at the time of reproduction, the reproduced image from the hologram recording medium 100 is detected by the image sensor 103 and the data reproduction is performed by a data reproducing section 21 in the drawing.

In addition, an optical system for performing illumination of laser light for position control and detection of reflected light of the laser light for position control is also provided in the recording/reproduction apparatus shown in FIG. 24. Specifically, the optical system includes a second laser 14, a collimation lens 15, a polarization beam splitter 16, a condensing lens 17, and a photodetector (PD) 18 in the drawing.

The second laser 14 outputs, as laser light for position control, the above-described red laser light with a wavelength λ of about 650 nm. The emitted light from the second laser 14 is incident on the dichroic mirror 8 through the collimation lens 15 and the polarization beam splitter 16. Here, the polarization beam splitter 16 is also configured to transmit p-polarized light and reflect s-polarized light.

As described above, the dichroic mirror 8 is configured to selectively reflect laser light for recording/reproduction (in this case, 405 nm). Accordingly, the laser light for position control from the second laser 14 is transmitted through the dichroic mirror 8.

Similar to the laser light for recording/reproduction, the laser light for position control recording/reproduction transmitted through the dichroic mirror 8 illuminates the hologram recording medium 100 through the partial diffraction element 9, the ¼ wavelength plate 10, and the objective lens 102.

Moreover, for clarity, the laser light for position control and the laser light for recording/reproduction are mixed on the same optical axis since the dichroic mirror 8 is provided, and the mixed light illuminates the hologram recording medium 100 through the common objective lens 102. That is, in this manner, the beam spot of the laser light for position control and the beam spot of the laser light for recording/reproduction are formed at the same position in the in-plane direction of the recording surface. As a result, since a position control operation based on the laser light for position control, which will be described below, is performed, the recording/reproduction position of a hologram is controlled to be positioned on a track.

In addition, the focusing direction is controlled by the position control operation (focus servo control), which will be described below, such that the focal position of the laser light for position control is positioned on the reflective layer L2 of the hologram recording medium 100 (see FIG. 34).

In this case, in the recording/reproduction apparatus, an adjustment is performed such that the focal position of the laser light for position control and the focal position of the laser light for recording/reproduction are spaced apart from each other by a predetermined distance. Specifically, in this case, since the laser light for recording/reproduction is condensed on the reflective layer L5 located immediately below the recording layer L4, the adjustment is performed such that the focal position of the laser light for recording/reproduction is at the deep side (lower layer side) from the focal position of the laser light for position control by a distance from the surface of the reflective layer L2 to the surface of the reflective layer L5 (refer to FIG. 23).

Thus, since the focus servo which locates the focal position of the laser light for position control on the reflective layer L2 is performed, the focal position of the laser light for recording/reproduction is automatically located on the reflective layer L5.

In FIG. 24, when the laser light for position control illuminates the hologram recording medium 100, the reflected light corresponding to the recorded information on the reflective layer L2 is obtained. This reflected light is incident on the polarization beam splitter 16 through the objective lens 102, the ¼ wavelength plate 10, the partial diffraction element 9, and the dichroic mirror 8. The polarization beam splitter 16 reflects the reflected light of the laser light for position control which has been incident through the dichroic mirror 8 as described above (laser light for position control reflected by the hologram recording medium 100 is also converted into s-polarized light by the function of the ¼ wavelength plate 10). The reflected light of the laser light for position control reflected by the polarization beam splitter 16 is illuminated so as to be condensed on a detection surface of the photodetector 18 through the condensing lens 17.

The photodetector 18 receives the reflected light of the laser light for position control illuminated as described above, converts the reflected light into an electric signal, and supplies the electric signal to the position control section 19.

The position control section 19 includes a matrix circuit which generates various kinds of signals necessary for position control, such as a reproduction signal (RF signal), a tracking error signal, and a focus error signal, for a pit sequence formed on a reflective layer 109 by matrix operation, an operation circuit for servo signal generation, and a driving control section which controls driving of a necessary section, such as the biaxial mechanism 12.

Although not shown, an address detection circuit or a clock generation circuit for performing detection of the address information or generation of a clock on the basis of the reproduction signal is provided in the recording/reproduction apparatus. In addition, a slide driving section which holds the hologram recording medium 100 so as to be movable in the tracking direction (radial direction), for example, is also provided.

The position control section 19 controls the beam spot position of the laser light for position control by controlling the biaxial mechanism 12 and the slide driving section on the basis of the address information or the tracking error signal. By such control of the beam spot position, the beam spot position of the laser light for recording/reproduction may be moved to the necessary address and may be made to follow on the track (tracking servo control). That is, the recording/reproduction position of a hologram is controlled by such control of the beam spot position.

In addition, the position control section 19 also performs focus servo control for making the focus position of the laser light for position control follow on the reflective layer L2 by controlling an operation of the biaxial mechanism 12 for driving the objective lens 102 in the focusing direction on the basis of the focus error signal. As also described previously, since the focus servo control is performed on such laser light for position control, the focus position of the laser light for recording/reproduction is made to follow on the reflective layer L5.

### SUMMARY OF THE INVENTION

Here, in the hologram recording/reproduction system which adopts the above-described coaxial method, resistance to the inclination (tilt) of a recording medium is low. For example, the tilt tolerance becomes very small compared with that in a recording/reproduction system for a current high density optical disc, such as a BD (Blu-ray Disc: registered trademark). Therefore, in the hologram recording/reproduction system using the coaxial method, it is one of the important issues to improve the tilt tolerance in practical application.

In general, deterioration of a reproduction signal caused by tilt in an optical disc system is mainly due to a coma aberration. Also in the hologram recording/reproduction system, occurrence of the coma aberration caused by tilt largely deteriorates a reproduction signal.

Here, the reason why the tilt tolerance in the hologram recording/reproduction system which adopts the coaxial method is smaller than that in the current optical disc system, such as a BD, as described above is because the recording/reproduction principle are very different.

First, occurrence of a coma aberration caused by tilt will be described with reference to FIGS. 26A and 26B. FIGS. 26A and 26B are diagrams schematically illustrating the occurrence of a coma aberration caused by tilt. FIG. 26A shows the situation of laser light for recording/reproduction, which is incident on the hologram recording medium 100 when there is no tilt, and FIG. 26B shows the situation of laser light for recording/reproduction, which is incident on the hologram recording medium 100 when the tilt occurs, in a state where the cover layer L1 to the substrate L3, the recording layer L4, and the reflective layer L5 in the hologram recording medium 100 are shown.

First, as can be seen from FIG. 26A, the angle of laser light that illuminates the hologram recording medium 100 through the objective lens 102, excluding the middle light, is changed according to the refractive index of the hologram recording medium 100 when the laser light is incident on the medium. In the recording/reproduction apparatus, in consideration of such angle variation when the laser light is incident on the medium, adjustment of the optical system, adjustment of the distance between the objective lens 102 and the medium setting position, and the like are performed such that the laser light for recording/reproduction is focused on the reflective layer L5.

As shown in FIG. 26A, when there is no tilt, the sectional shape of the laser light beams is symmetrical with respect to the optical axis. This state is a state with no phase difference.

On the other hand, when tilt occurs in the state in FIG. 26A, the shape of light changes as shown in FIG. 26B. That is, when a tilt occurs, the sectional shape of light beams is not symmetrical and the light beams are not condensed at one point unlike FIG. 26A. As a result, a coma aberration occurs.

Due to the occurrence of a coma aberration (tilt), the phase difference of light occurs. That is, a total of three light beams including light beams in the outermost peripheral portions (two places) and light in the middle among the light beams for recording/reproduction are shown in the drawing. However, when a tilt occurs, the laser optical axis is relatively inclined with respect to the recording medium. Accordingly, also for the light in the middle, the angle variation at the time of incidence occurs. In addition, when a tilt occurs, the light in each outermost peripheral portion propagates through the medium at a different angle from the case shown in FIG. 26A.

As a result, a phase difference occurs in each light compared with the case shown in FIG. 26A.

FIG. 27 is a diagram for comparing the reproduction wave front when a coma aberration occurs. (a) to (c) in FIG. 27 show the reproduction wave front in the case of a recording/reproduction system for a BD, and (d) to (f) in FIG. 27 show the reproduction wave front in the case of a hologram recording/reproduction system.

(a) and (d) in FIG. 27 show the reproduction wave front in a middle portion of principal light when a coma aberration occurs due to tilt.

(b) and (e) in FIG. 27 show the reproduction wave front when the laser spot at the time of occurrence of a coma aberration is viewed from the position where the RMS (Root Mean Square) value becomes minimum, that is, the position where the light intensity becomes strongest.

In addition, (c) and (f) in FIG. 27 show the reproduction wave front when the RMS value is 0.07λ, what is called Marechal criterion.

Moreover, in each drawing, the reproduction wave front is expressed by a circle using a solid line, and a plane which is expressed by a dotted circle indicates a wave front (reference wave front) with a phase difference of zero.

Here, as shown in the drawing, in the case of a BD system, a distance t from the recording medium surface to the focal position (that is, a distance from the recording medium surface to the reflection surface) is 0.1 mm. On the other hand, in the case of a hologram system, t=0.7 mm.

In addition, the difference in the value of t is caused by the difference in the structure of each recording medium. In the simulation shown in (a) to (f) in FIG. 27, in both the cases of BD and hologram, the cover thickness (here, defined as a distance from the surface to the recording layer) is set to 0.1 mm. In the case of a BD, since the medium structure is like “cover layer→reflective layer (information recording layer)”, the value of t is set to 0.1 mm which is the same as the thickness of the cover layer. On the other hand, in the case of a hologram system, the medium structure is like “cover layer (including the reflective layer L2 and the substrate L3)→recording layer→reflective layer”. Here, since the thickness of the recording layer is set to 0.6 mm, the value of t becomes 0.7 mm for the same cover thickness of 0.1 mm.

In addition, NA of the objective lens and the refractive index n of the recording medium are the same in both the cases of BD and hologram system. That is, NA=0.85 and the refractive index n of the recording medium=1.55.

First, the case of a BD will be described.

As shown in (a) in FIG. 27, in the case of a BD, a reproduction wave front in a middle portion of principal light has a phase difference of +λ˜−λ with respect to the reference wave front when TILT=1.14°.

When TILT=1.14°, the reproduction wave front when a laser spot is viewed at the position where the light intensity is the maximum becomes that shown in (b) in FIG. 27. In this case, the reproduction wave front has a phase difference of +0.33λ˜−0.33λ with respect to the reference wave front. In this case, the RMS value becomes 0.118λ as shown in the drawing.

In addition, in the case of a BD, the tilt angle TILT which becomes the Marechal criterion (RMS=0.07λ: approximately 80 percent of that when there is no aberration in terms of the light intensity) becomes 0.68° as shown in (c) in FIG. 27. In this case, the reproduction wave front has a phase difference of +0.20λ˜−0.20λ, as shown in the drawing.

(d) in FIG. 27 shows a reproduction wave front when TILT=0.16° which is a reproduction wave front in the case of a hologram system. First, in the case of a hologram system, it should be noted that a plurality of reproduction wave fronts exist as shown in the drawing.

Here, in hologram recording/reproduction, the reference light is formed by light from a number of pixels in the SLM 101. That is, the light from a number of pixels illuminates the hologram recording medium 100 through the objective lens 102. A hologram is formed by interference between each of signal light beams, which are similarly light beams from a number of pixels, and each of light beams from a number of pixels of the reference light.

In addition, as also can be understood from this, the recorded signal light of each pixel is reproduced by each of the light beams from a number of pixels of the reference light at the time of reproduction. That is, in the hologram recording/reproduction system, wave fronts of a number of reproduced images reproduced from a number of reference light beams exist as the reproduction wave front.

When tilt does not occur and the phase difference of reference light caused by a coma aberration does not occur, a number of reproduction wave fronts are equal. However, when the coma aberration occurs due to tilt and the phase difference occurs in the reference light, a plurality of wave fronts reproduced by a plurality of light beams with different phases exists as reproduction wave fronts. Accordingly, these wave fronts are not equal.

In this case, if a plurality of reproduced images with different phases exists, the respective light intensities are cancelled. As a result, the intensity of a reproduced image significantly drops. From this point, in the case of a hologram recording/reproduction system, a drop in the light intensity becomes noticeable when the coma aberration occurs due to tilt. This is a cause of narrowing the tilt tolerance.

This explanation continues referring back to the above drawings.

As shown in (d) in FIG. 27, in the case of a hologram system, the reproduction wave front has a phase difference of ±λ (1.0λ) with respect to the reference wave front at the time of TILT=0.16°. As shown in (a) in FIG. 27, in the case of a BD, the phase difference was ±λ at the time of TILT=1.14°. This is because t is 0.7 mm in the case of a hologram while t is 0.1 mm in the case of a BD.

(e) in FIG. 27 shows the case seen from the position where the RMS value is the minimum. In the case of a hologram system, even if seen from the position where the RMS value is the minimum, the phase difference of the reproduction wave front is ±λ. In this case, the RMS becomes 0.707λ, which is a larger value than in the BD case ((b) in FIG. 27) with the same conditions.

(f) in FIG. 27 shows the reproduction wave front at the time of Marechal criterion. In the case of a hologram system, the tilt angle TILT at the time of Marechal criterion is smaller than that in the case of a BD because the intensities are cancelled by the phase difference between reference light beams at the time of reproduction as described above. In the case of a hologram, the tilt angle at the time of Marechal criterion is TILT=±0.016° which is about 1/42 of that in the case of a BD. Moreover, in this case, the reproduction wave front has a phase difference of ±0.1λ.

As also can be understood from the above explanation, particularly when the coaxial method is adopted as the hologram recording/reproduction method, deterioration of a reproduction signal when a coma aberration occurs (when the phase difference between reference light beams occurs) due to tilt is especially larger than that in the case of a current optical disc system because of the recording/reproduction principle. Therefore, in the hologram recording/reproduction system using the coaxial method, it is an important issue to improve the tilt tolerance in practical application.

Examples of the above-described related art are disclosed in Japanese Unexamined Patent Application Publication Nos. 2005-71557 and 2007-58129.

In view of the above, according to an embodiment of the present invention, there is provided a recording/reproduction method of performing recording/reproduction of a hologram by illuminating a hologram recording medium, which has a recording layer in which information is recorded by interference fringes between signal light and reference light, with the signal light and/or the reference light as recording/reproduction light through an objective lens including the step of: setting a focal position of the recording/reproduction light such that a distance from a surface of the hologram recording medium to the focal position of the recording/reproduction light is larger than a distance from the surface to a lower-layer-side surface of the recording layer and illuminating the hologram recording medium including an angle-selective reflective layer, which is formed below the recording layer and has a selective light reflection/transmission characteristic depending on a light incidence angle, with the recording/reproduction light the focal position of which has been set.

Furthermore, according to another embodiment of the present invention, there is provided a hologram recording medium including: a recording layer in which information is recorded by interference fringes between signal light and reference light; and an angle-selective reflective layer which is formed below the recording layer and has a selective light reflection/transmission characteristic depending on a light incidence angle.

Here, assuming that the numerical aperture of the objective lens is NA and the distance from the surface of the hologram recording medium to the focal position of the recording/reproduction light is t, the amount of occurrence W of a coma aberration is expressed as W∝NA³·t. That is, the amount of occurrence W of the coma aberration can be suppressed by reducing NA of the objective lens or by reducing the value of t which is the distance from the surface to the focal position.

As described previously with reference to FIG. 23, the focal position of recording/reproduction light in the related art was on a lower-layer-side surface of the recording layer (upper-layer-side surface, that is, reflection surface of the reflective layer L5). That is, the value of “t” is a distance from the recording medium surface to the lower-layer-side surface of the recording layer. Accordingly, the value of “t” was a relatively large value including the thickness of a cover layer and a recording layer. Moreover, from this point, in the past hologram recording/reproduction system, the amount of occurrence W of the coma aberration caused by tilt tends to be relatively large.

On the other hand, according to the embodiment of the present invention, the value of “t” may be smaller than the distance from the recording medium surface to the lower-layer-side surface of the recording layer. Accordingly, the amount of occurrence W of the coma aberration caused by tilt can be suppressed more significantly than in the related art.

Thus, since the coma aberration caused by tilt can be suppressed, the tilt margin can be increased.

However, in the case of adopting a method of shifting the focal position to the more upper layer side than in the related art, a useless exposed portion where only some signal light beams overlap the reference light is generated in the recording layer because the light states of the signal light and reference light transmitted through the recording layer change from those in the related art (see FIG. 7 or 8).

The useless exposed portion is a portion where media (recording material) is consumed even though effective information recording is not performed. When multiple recording of a hologram is performed, the useless exposed portion lowers the S/NR (S/N ratio). That is, as also can be understood from this point, such a useless exposed portion reduces the recording density of a hologram.

Therefore, in the hologram recording medium according to the embodiment of the present invention, in the case of adopting the method of shifting the focal position, the angle-selective reflective layer is provided below the recording layer as described above.

Here, in the coaxial method of illuminating the signal light and the reference light through a common objective lens, a difference occurs between the medium incidence angle of the signal light and the medium incidence angle of the reference light. From this point, if the above-described angle-selective reflective layer is provided, the signal light (reproduced light at the time of reproduction) can be reflected and the reference light can be transmitted according to the difference between the incidence angle of the signal light and the incidence angle of the reference light. Thus, if only the reference light can be selectively transmitted, components of the reference light (reflected reference light), which are reflected by the reflection surface and are transmitted through the recording layer again in the normal case, can be suppressed. As a result, the useless exposure described above can be suppressed. Moreover, since only the reference light is transmitted and the reproduction light is reflected in this case, a reproduction operation is not adversely affected.

As described above, according to the embodiment of the present invention, the focal position of the recording/reproduction light which was on the lower-layer-side surface of the recording layer (reflection surface of the reflective layer) in the related art is located to be closer to the recording medium surface. Accordingly, the amount of occurrence of the coma aberration when tilt occurs can be suppressed more than in the related art. As a result, the tilt tolerance can be improved.

In addition, in the present invention, a method of reducing NA of the objective lens in order to suppress the amount of occurrence of the coma aberration is not adopted. Accordingly, the tilt tolerance can be improved without lowering the information recording/reproduction density.

Moreover, in the hologram recording medium according to the embodiment of the present invention, the angle-selective reflective layer is provided below the recording layer. Accordingly, the useless exposure in the recording layer, which is a problem in the case of adopting the method of focal position shift described above, can be effectively suppressed. As a result, the recording density can be improved.

### BRIEF DESCRIPTION OF THE DRAWINGS

FIG. 1 is a diagram illustrating the configuration of a recording/reproduction apparatus as a past example (and an embodiment);

FIG. 2 is a diagram illustrating the reference light area, the signal light area, and the gap area set in a spatial light modulator;

FIG. 3 is a diagram illustrating the focal position of light for recording/reproduction set in the past example (and the embodiment);

FIG. 4 is a diagram illustrating a result after performing simulation regarding the relationship between set values of distance and NA of an objective lens and the reproduction tilt tolerance;

FIGS. 5A and 5B are diagrams illustrating examples of setting the distance between an objective lens and a hologram recording medium when changing the focal position of light for recording/reproduction;

FIG. 6 is a diagram illustrating the shape of a hologram formed in a hologram recording medium by a past recording/reproduction system;

FIG. 7 is a diagram illustrating the situation of signal light and reference light, which illuminate a hologram recording medium 100, and return path light thereof in the past example (and the embodiment);

FIG. 8 is a diagram illustrating the shape of a hologram formed in a hologram recording medium in the past example (and the embodiment);

FIG. 9 is a diagram illustrating how a recorded hologram is reproduced in the past example (and the embodiment);

FIG. 10 is a diagram illustrating the behavior of light in the entire optical system in the past case;

FIG. 11 is a diagram illustrating the behavior of light in the entire optical system for forward path light at the time of the recording in the past example (and the embodiment);

FIG. 12 is a diagram illustrating the behavior of light in the entire optical system for return path light at the time of the reproduction in the past example (and the embodiment);

FIG. 13 is a diagram illustrating the reason why the position of forward path light is equal to the position of return path light on the actual image surface in the past case (and the embodiment);

FIG. 14 is a diagram illustrating a simulation result for each item of tilt tolerance, diffraction efficiency, and SNR (S/N ratio);

FIG. 15 is a diagram illustrating the sectional structure of a hologram recording medium as an embodiment;

FIGS. 16A and 16B are diagrams illustrating the specific light reflection/transmission characteristic of an angle-selective reflective layer;

FIG. 17 is a diagram illustrating a hologram recorded in the embodiment;

FIG. 18 is a diagram illustrating a specific configuration example of the angle-selective reflective layer;

FIG. 19 is a diagram illustrating the light reflection/transmission characteristic of the angle-selective reflective layer which is made to have the structure shown in FIG. 18;

FIG. 20 is a diagram illustrating a specific configuration example of a light absorption layer;

FIG. 21 is a diagram illustrating a recording method of a hologram based on a coaxial method;

FIGS. 22A and 22B are diagrams illustrating a reproduction method of a hologram based on the coaxial method;

FIG. 23 is a sectional view showing a structure example of a hologram recording medium;

FIG. 24 is a diagram illustrating the internal configuration of a recording/reproduction apparatus as a past example;

FIGS. 25A and 25B are diagrams illustrating intensity modulation realized by combination of a polarization direction control type spatial light modulator and a polarization beam splitter;

FIGS. 26A and 26B are diagrams illustrating occurrence of a coma aberration caused by tilt; and

FIG. 27 is a diagram illustrating a reproduction wave front in the case of a BD and a reproduction wave front in the case of a hologram system for comparison.

### DESCRIPTION OF THE PREFERRED EMBODIMENTS

Hereinafter, best modes (hereinafter, referred to as embodiments) for carrying out the present invention will be described. In addition, the explanation is made in following order.

<1. Hologram recording/reproduction system as a past example>

[1-1. Configuration of a recording/reproduction apparatus]

[1-2. Suppression of a coma aberration caused by tilt]

(1-2-1. Specific suppression method)

(1-2-2. Specific method for focal position shift)

(1-2-3. Change in a behavior of light according to focal position shift)

[1-3. Simulation result]

[1-4. Conclusion of effects of the past example]

<2. Hologram recording/reproduction system as an embodiment>

[2-1. Problems in the past example]

[2-2. Hologram recording medium as an embodiment]

[2-3. Specific example of the layer structure]

<3. Modifications>

<1. Hologram Recording/Reproduction System as a Past Example>

[1-1. Configuration of a Recording/Reproduction Apparatus]

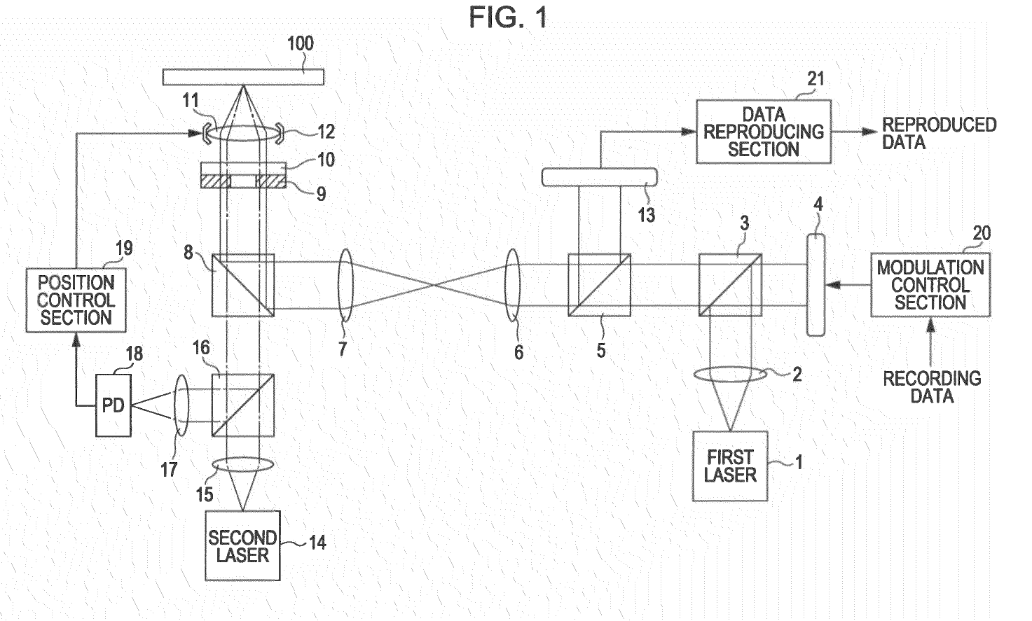

FIG. 1 shows the internal configuration of a recording/reproduction apparatus as a past example proposed by the applicant, prior to describing the present invention. In addition, FIG. 1 mainly shows the configuration of an optical system of the recording/reproduction apparatus.

Here, a hologram recording/reproduction system as an embodiment, which will be described later, has a feature mainly in the structure of a hologram recording medium, and the configuration of the recording/reproduction apparatus is the same as that shown in FIG. 1.

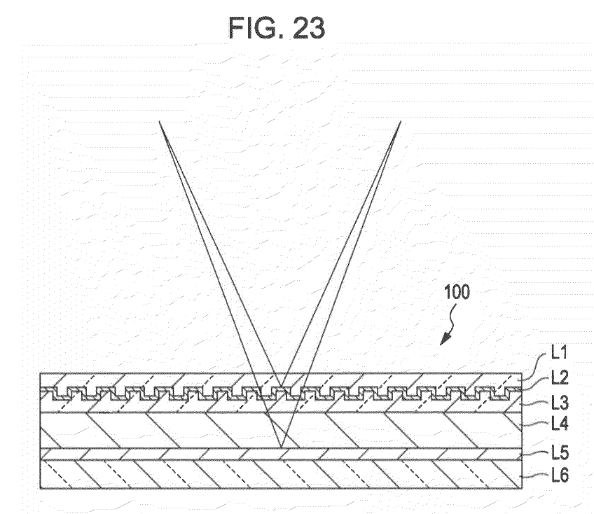

First, referring to FIG. 1, a hologram recording medium 100 is the same as that shown in FIG. 23. For clarity, a cover layer L1, a reflective layer L2, a substrate L3, a recording layer L4, a reflective layer L5, and a substrate L6 are formed from the upper layer side to the lower layer side in the hologram recording medium 100.

In addition, assuming that a surface on which light for recording/reproduction is incident is an upper surface and a surface located at the opposite side of the upper surface is a lower surface, the “upper layer” and “lower layer” referred to herein correspond to the upper surface side and the lower surface side, respectively.

In this case, the cover layer L1 is formed of plastic or glass, for example, and is provided to protect the recording layer L2 formed below the cover layer L1.

The reflective layer L2 and the substrate L3 are provided to control the recording/reproduction position of a hologram, and a track for guiding the recording/reproduction position of a hologram in the recording layer L4 is formed in a spiral or concentric shape in the substrate L3. In this case, the track is formed by performing information recording of the address information or the like using a pit sequence. The reflective layer L2 is formed on a surface (top surface) of the substrate L3 in which the track is formed, for example, by sputtering or vapor deposition.

As described previously, a layer having wavelength selectivity is selected as the reflective layer L2. Also in this example, purple-blue laser light with a wavelength λ of about 405 nm is illuminated as laser light for hologram recording/reproduction and red laser light with a wavelength λ of about 650 nm, for example, is illuminated as laser light for position control, similar to those described above. As a result, for the reflective layer L2, a reflective layer with wavelength selectivity which transmits the purple-blue laser light for recording/reproduction and reflects the red laser light for position control is used.

In addition, a material in which the information can be recorded by a change in the refractive index according to the intensity distribution of illuminated light, such as photopolymer, is selected as a material of the recording layer L4, and recording/reproduction of a hologram is performed by the laser light for recording/reproduction.

In addition, the reflective layer L5 formed below the recording layer L4 is provided in order that, when a reproduced image corresponding to the hologram recorded in the recording layer L4 is acquired by illumination of the reference light at the time of reproduction, the reproduced image is returned to the apparatus side as reflected light.

The substrate L6 formed below the reflective layer L5 has a function as a protective layer, similar to the cover layer L1. Accordingly, the substrate L6 is formed of a transparent material, such as plastic or glass.

This explanation continues referring back to FIG. 1.

In the recording/reproduction apparatus, the hologram recording medium 100 is held so as to be rotatable by a spindle motor (not shown). In the recording/reproduction apparatus, the hologram recording medium 100 in the held state is illuminated with laser light for recording/reproduction of a hologram and laser light for position control.

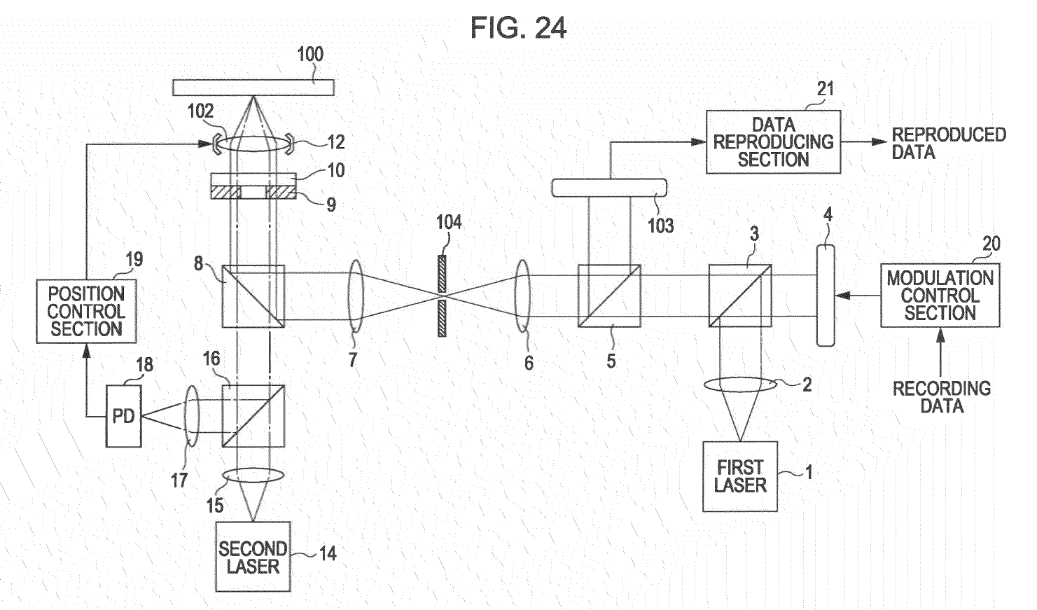

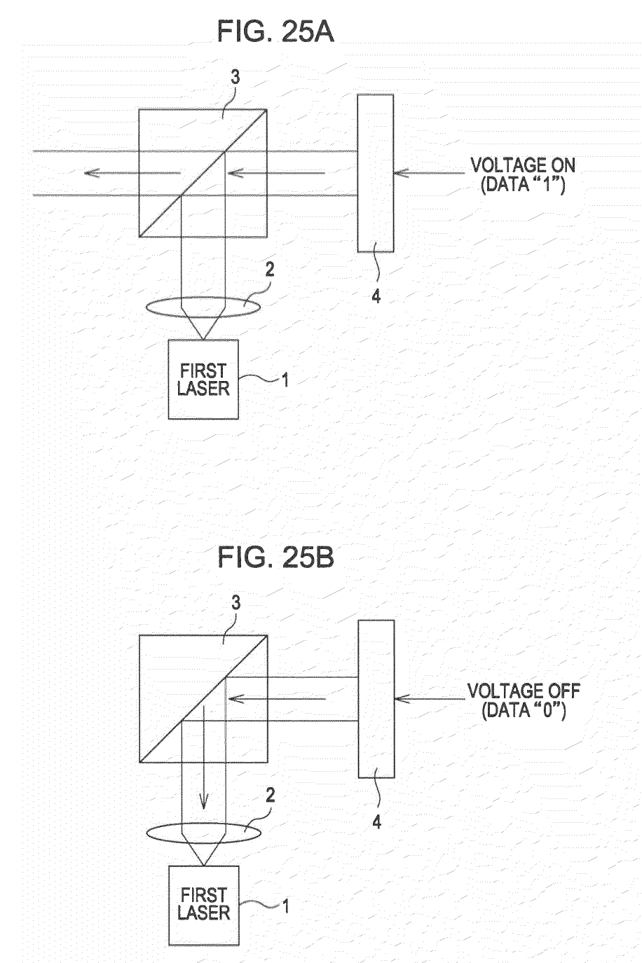

In FIG. 1, the same sections as in the recording/reproduction apparatus shown in FIG. 24 are denoted by the same reference numerals. As can be understand by comparison with FIG. 24, the recording/reproduction apparatus in this example has approximately the same configuration as the recording/reproduction apparatus in the past. The recording/reproduction apparatus in this example performs recording/reproduction of a hologram by illumination of recording/reproduction light from a first laser 1 as a light source and also performs control (also including focus servo) of the recording/reproduction position of a hologram by illumination of position control light from a second laser 14 as a light source.

Moreover, also in the recording/reproduction apparatus in this example, the coaxial method is adopted as a hologram recording/reproduction method. That is, signal light and reference light are disposed on the same axis and both the signal light and the reference light illuminate a hologram recording medium set at a predetermined position, so that data recording is performed by formation of a hologram. In addition, at the time of reproduction, a reproduced image (reproduction signal light) of the hologram is acquired by illuminating the hologram recording medium with the reference light, so that the recorded data can be reproduced.

In the recording/reproduction apparatus in this example, the first laser 1, a collimation lens 2, a polarization beam splitter 3, an SLM 4, a polarization beam splitter 5, a relay lens 6, a relay lens 7, a dichroic mirror 8, a partial diffraction element 9, a ¼ wavelength plate 10, an objective lens 11, and an image sensor 13 are provided as an optical system for illumination of the reference light and the signal light for recording/reproduction of a hologram.

Also in this case, the first laser 1 outputs, for example, the purple-blue laser light with a wavelength λ of about 405 nm as laser light for recording/reproduction of a hologram. The laser light emitted from the first laser 1 is incident on the polarization beam splitter 3 through the collimation lens 2.

Also in this case, an intensity modulating section which performs spatial light intensity modulation on the incident light is formed by the polarization beam splitter 3 and the SLM 4. Also in this case, the polarization beam splitter is configured to transmit p-polarized light and reflect s-polarized light, for example. Accordingly, only an s-polarized light component of the laser light incident on the polarization beam splitter 3 is reflected and guided to the SLM 4.

The SLM 4 includes a reflective liquid crystal element as an FLC (Ferroelectric Liquid Crystal), for example, and is configured to control the polarization direction of the incident light in the pixel unit.

The SLM 4 performs spatial light modulation by changing the polarization direction of the incident light by 90° according to a driving signal from a modulation control section 20 in the drawing for every pixel or without changing the polarization direction of the incident light. Specifically, the SLM 4 is configured to perform the polarization direction control according to a driving signal in the pixel unit such that an angle variation of the polarization direction is set to 90° for a pixel for which a driving signal is ON and an angle variation of the polarization direction is set to 0° for a pixel for which the driving signal is OFF.

The emitted light (light reflected by the SLM 4) from the SLM 4 is incident on the polarization beam splitter 3 again. Then, the light (p-polarized light) through an ON pixel of the SLM 4 is transmitted through the polarization beam splitter 3, and the light (s-polarized light) through an OFF pixel is reflected by the polarization beam splitter 3. As a result, the intensity modulating section which performs spatial light intensity modulation (also simply referred to as intensity modulation) on the incident light in the pixel unit of the SLM 4 is realized.

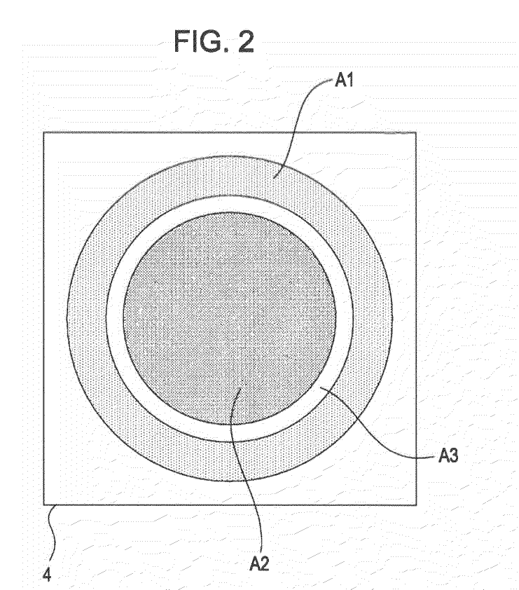

Here, when the coaxial method is adopted, each area shown in FIG. 2 is set in the SLM 4 in order to dispose the signal light and the reference light on the same optical axis.

As shown in FIG. 2, in the SLM 4, the area within a predetermined circular range including the center (matched with the center of the optical axis) is set as a signal light area A2. In addition, a ring-shaped reference light area A1 is set in the outside of the signal light area A2 with a gap area A3 interposed therebetween.

By setting of the signal light area A2 and the reference light area A1, the signal light and the reference light can be illuminated so as to be disposed on the same optical axis.

In addition, the gap area A3 is set as a region for preventing the reference light generated in the reference light area A1 from leaking into the signal light area A2 and becoming signal light noise.

For clarity, the signal light area A2 is not circular in the strict sense because the pixel shape of the SLM 4 is rectangular. Similarly, the reference light area A1 and the gap area A3 do not have the ring shape in the strict sense. Regarding these meanings, the signal light area A2 has an approximately circular shape, and each of the reference light area A1 and the gap area A3 has an approximately ring shape.

Referring to FIG. 1, the modulation control section 20 performs driving control of the SLM 4 so that signal light and reference light are generated at the time of recording and only the reference light is generated at the time of reproduction.

Specifically, at the time of recording, the modulation control section 20 generates a driving signal which makes pixels in the signal light area A2 of the SLM 4 have an ON/OFF pattern corresponding to the supplied recording data, makes the pixels in the reference light area A1 have a predetermined ON/OFF pattern set beforehand, and turns off the other pixels, and supplies the driving signal to the SLM 4. By performing the spatial light modulation (polarization direction control) on the basis of the driving signal by the SLM 4, signal light and reference light which are disposed to have the same center (optical axis) are obtained as the emitted light from the polarization beam splitter 3.

In addition, at the time of reproduction, the modulation control section 20 controls the driving of the SLM 4 by a driving signal, which makes the pixels in the reference light area A1 have a predetermined ON/OFF pattern and turns off the other pixels. As a result, only the reference light is generated.

In addition, at the time of recording, the modulation control section 20 operates such that an ON/OFF pattern within the signal light area A2 is generated for every predetermined unit of the input recording data stream and accordingly, signal light in which the data is stored for every predetermined unit of the recording data stream is generated in a sequential manner. Thus, the data is sequentially recorded in the hologram recording medium 100 in the hologram page unit (data unit recordable by one-time interference between the signal light and the reference light).

The laser light which has been subjected to the intensity modulation in the intensity modulating section formed by the polarization beam splitter 3 and the SLM 4 is incident on the polarization beam splitter 5. The polarization beam splitter 5 is also configured to transmit p-polarized light and reflect s-polarized light. Accordingly, the laser light is transmitted through the polarization beam splitter 5.

The laser light transmitted through the polarization beam splitter 5 is incident on the relay lens system in which the relay lens 6 and the relay lens 7 are disposed in this order. As shown in the drawing, the relay lens 6 makes the laser light beams, which have been transmitted through the polarization beam splitter 5, condensed at the predetermined focal position, and the relay lens 7 converts the laser light beams as diffused light after the condensing into parallel light.

The laser light transmitted through the relay lens system is incident on the dichroic mirror 8. The dichroic mirror 8 is configured to selectively reflect the light within a predetermined wavelength range. Also in this case, the dichroic mirror 8 is configured to selectively reflect light in a wavelength range of the laser light for recording/reproduction with a wavelength λ of about 405 nm. Accordingly, the laser light for recording/reproduction which has been incident through the relay lens system is reflected by the dichroic mirror 8.

The laser light for recording/reproduction reflected by the dichroic mirror 8 is incident on the objective lens 11 through the partial diffraction element 9 and the 1/4 wavelength plate 10. Also in this case, the partial diffraction element 9 is obtained by forming a polarization-selective diffraction element which has a selective diffraction characteristic (one linearly polarized light component is diffracted and the other linearly polarized light component is transmitted) according to a polarization state of linearly polarized light, such as a liquid crystal diffraction element, in a region on which the reference light is incident. Specifically, the polarization-selective diffraction element provided in the partial diffraction element 9 is configured to transmit p-polarized light and diffract s-polarized light.

In addition, the ¼ wavelength plate 10 is set such that the optical reference axis is inclined by 45° with respect to the polarization direction axis of incident light (in this case, p-polarized light) and functions as linearly polarized light/circularly polarized light conversion element.

A drop in S/N ratio (S/N) caused by return path reference light (reflected reference light) obtained as reflected light from the hologram recording medium 100 can be prevented by the partial diffraction element 9 and the ¼ wavelength plate 10. That is, the reference light in the forward path which is incident as p-polarized light is transmitted through the partial diffraction element 9. In addition, the reference light (reflected reference light) in the return path which is incident as s-polarized light through the hologram recording medium 100 (reflective layer L5), the objective lens 11, and the ¼ wavelength plate 10 is diffracted (suppressed) by the partial diffraction element 9.

As also described previously, the reflected reference light is light with very large intensity compared with a reproduced image of a hologram obtained using the diffraction phenomenon. Accordingly, the reflected reference light becomes a noise component, which is difficult to neglect, against the reproduced image. For this reason, if the reflected reference light is guided to the image sensor 13, the S/N ratio significantly drops. Such a drop in the S/N ratio can be effectively prevented by suppressing the reflected reference light using the partial diffraction element 9 and the ¼ wavelength plate 10.

Also in this case, a region (that is, a region on which a reproduced image is incident) of the partial diffraction element 9 on which signal light is incident is formed to transmit both the forward path light and the return path light. For example, the region is formed of a transparent material or formed as a hole. Thus, the signal light at the time of recording can appropriately illuminate the hologram recording medium 100 and the reproduced image at the time of reproduction can be appropriately guided to the image sensor 13.

The objective lens 11 is held so as to be movable in a direction (focusing direction), which becomes close to or distant from the hologram recording medium 100, and in a radial direction (tracking direction) of the hologram recording medium 100 by the biaxial mechanism 12 shown in the drawing. The position control section 19, which will be described later, controls an operation of the biaxial mechanism 12 for driving the objective lens 11, thereby controlling the spot position of the laser light.

The laser light for recording/reproduction illuminates the hologram recording medium 100 after being condensed by the objective lens 11.

Here, as also described previously, at the time of recording, the signal light and the reference light are generated by intensity modulation of the intensity modulating section (SLM 4 and polarization beam splitter 3) based on the control of the modulation control section 20. Then, the signal light and the reference light illuminate the hologram recording medium 100 through the path described above. As a result, a hologram which reflects the recording data is formed in the recording layer L4 by the interference fringes between the signal light and the reference light. That is, the data recording is performed.

In addition, at the time of reproduction, only the reference light is generated on the basis of the control of the modulation control section 20 by the intensity modulating section, and the reference light illuminates the hologram recording medium 100 through the path described above. By such illumination of the reference light, a reproduced image corresponding to the hologram formed in the recording layer L4 can be obtained as reflected light from the reflective layer L5. This reproduced image is returned to the apparatus side through the objective lens 11.

As described above, in the partial diffraction element 9, the signal light incidence region is a transmissive region. Therefore, the reproduced image which has been acquired from the hologram recording medium 100 as described above and has been transmitted through the objective lens 11 and the ¼ wavelength plate 10 is transmitted through the partial diffraction element 9. The reproduced image transmitted through the partial diffraction element 9 is reflected by the dichroic mirror 8 and is then incident on the polarization beam splitter 5 through the relay lens system (relay lens 7→relay lens 6) described above. Since the reflected light from the hologram recording medium 100 is converted into s-polarized light by the function of the ¼ wavelength plate 10, the reproduced image incident on the polarization beam splitter 5 as described above is reflected by the polarization beam splitter 5 and is then incident on the image sensor 13.

The image sensor 13 is formed by using a CCD (Charge Coupled Device) sensor or a CMOS (Complementary Metal Oxide Semiconductor) sensor, receives the reproduced image from the hologram recording medium 100 which has been guided as described above, and converts the reproduced image into an electric signal to thereby acquire an image signal. The image signal obtained as described above reflects the ON/OFF pattern (that is, data pattern of “0” and “1”) given to the signal light at the time of recording. That is, the image signal detected as described above by the image sensor 13 becomes a read signal of the data recorded in the hologram recording medium 100.

The image signal as the read signal acquired by the image sensor 13 is supplied to the data reproducing section 21.

The data reproducing section 21 reproduces the recording data by performing data identification of “0” and “1” for every value in the pixel unit of the SLM 4, which is included in the image signal from the image sensor 13, and performing demodulation processing of a recording modulation code and the like when necessary.

By the configuration described up to now, the recording/reproduction operation of a hologram based on illumination of the light for recording/reproduction using the first laser 1 as a light source is realized.

Moreover, in addition to the above-described optical system for recording/reproduction of a hologram, the second laser 14, the collimation lens 15, the polarization beam splitter 16, the condensing lens 17, and the photodetector (PD) 18 are provided in the recording/reproduction apparatus shown in FIG. 1 as an optical system (position control optical system) for controlling the recording/reproduction position of a hologram.

In this position control optical system, the second laser 14 outputs, as laser light for position control, the above-described red laser light with a wavelength λ of about 650 nm. The emitted light from the second laser 14 is incident on the dichroic mirror 8 through the collimation lens 15 and the polarization beam splitter 16. Here, the polarization beam splitter 16 is also configured to transmit p-polarized light and reflect s-polarized light.

As described above, the dichroic mirror 8 is configured to selectively reflect light in a wavelength range of the laser light for recording/reproduction (in this case, λ is about 405 nm). Accordingly, the laser light for position control from the second laser 14 is transmitted through the dichroic mirror 8.

Similar to the laser light for recording/reproduction, the laser light for position control recording/reproduction transmitted through the dichroic mirror 8 illuminates the hologram recording medium 100 through the partial diffraction element 9, the ¼ wavelength plate 10, and the objective lens 11.

Moreover, for clarity, the laser light for position control and the laser light for recording/reproduction are mixed on the same optical axis since the dichroic mirror 8 is provided, and the mixed light illuminates the hologram recording medium 100 through the common objective lens 11. That is, in this manner, the beam spot of the laser light for position control and the beam spot of the laser light for recording/reproduction are formed at the same position in the in-plane direction of the recording surface. As a result, since a position control operation based on the laser light for position control, which will be described below, is performed, the recording/reproduction position of a hologram is controlled to become a position along the track.

By such illumination of the laser light for position control, reflected light corresponding to the recorded information on the reflective layer L2 is obtained from the hologram recording medium 100. This reflected light (referred to as position control information reflection light) is incident on the polarization beam splitter 16 through the objective lens 11, the ¼ wavelength plate 10, the partial diffraction element 9, and the dichroic mirror 8. The polarization beam splitter 16 reflects the reflected light of the laser light for position control which has been incident through the dichroic mirror 8 as described above (laser light for position control reflected by the hologram recording medium 100 is also converted into s-polarized light by the function of the ¼ wavelength plate 10). The reflected light of the laser light for position control reflected by the polarization beam splitter 16 is illuminated so as to be condensed on a detection surface of the photodetector 18 through the condensing lens 17.

The photodetector 18 includes a plurality of photodetectors, receives the position control information reflection light from the hologram recording medium 100 illuminated through the condensing lens 17 as described above, and acquires an electric signal corresponding to the light receiving result. As a result, the reflected light information (reflected light signal) which reflects an uneven sectional shape formed on the substrate L3 (on the reflective layer L2) is detected.

Thus, the position control section 19 is provided as a configuration for performing various kinds of position control regarding the recording/reproduction position of a hologram, such as focus servo control, tracking servo control, and control of access to a predetermined address, on the basis of the reflected light information acquired by the photodetector 17.

The position control section 19 includes a matrix circuit which generates various kinds of signals necessary for position control, such as a reproduction signal (RF signal), a tracking error signal, and a focus error signal, for a pit sequence formed on the reflective layer L5 by matrix operation, an operation circuit for performing servo operation and the like, and a driving control section which controls driving of a necessary section, such as the biaxial mechanism 12.

Although not shown, an address detection circuit or a clock generation circuit for performing detection of the address information or generation of a clock on the basis of the reproduction signal is also provided in the recording/reproduction apparatus shown in FIG. 1. In addition, a slide driving section which holds the hologram recording medium 100 so as to be movable in the tracking direction, for example, is also provided.

The position control section 19 controls the beam spot position of the laser light for position control by controlling the biaxial mechanism 12 and the slide driving section on the basis of the address information or the tracking error signal. By such control of the beam spot position, the beam spot position of the laser light for recording/reproduction may be moved to the necessary address and may be made to follow the position along the track (tracking servo control). That is, the recording/reproduction position of a hologram is controlled by such control of the beam spot position.

In addition, the position control section 19 also performs focus servo control for making the focus position of the laser light for position control follow on the reflective layer L2 by controlling an operation of the biaxial mechanism 12 for driving the objective lens 11 in the focusing direction on the basis of the focus error signal. Accordingly, the focus position (focal position) of the laser light for recording/reproduction illuminated through the common objective lens 11 is also maintained as a predetermined position.

[1-2. Suppression of a Coma Aberration Caused by Tilt]

(1-2-1. Specific Suppression Method)

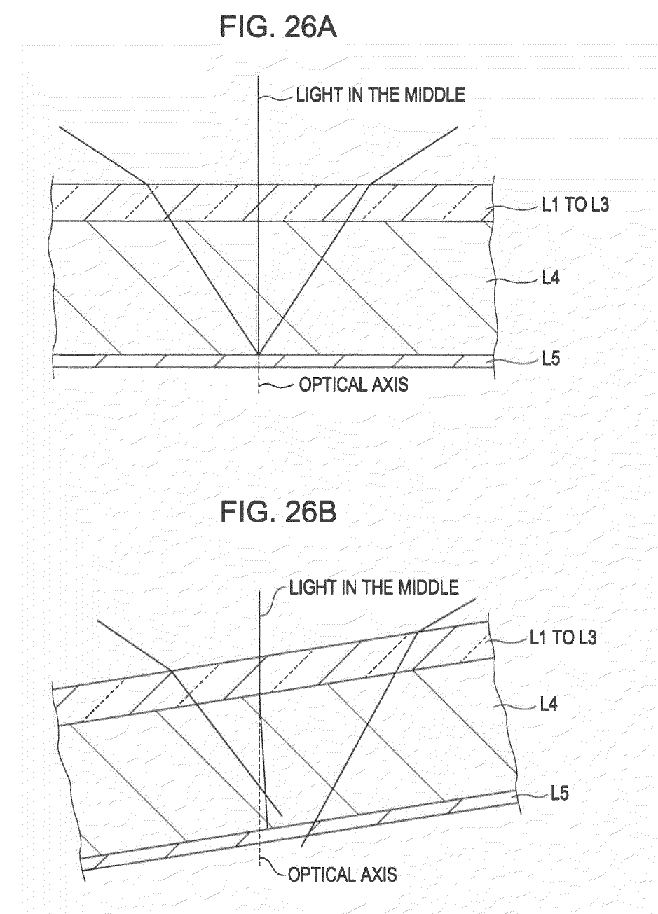

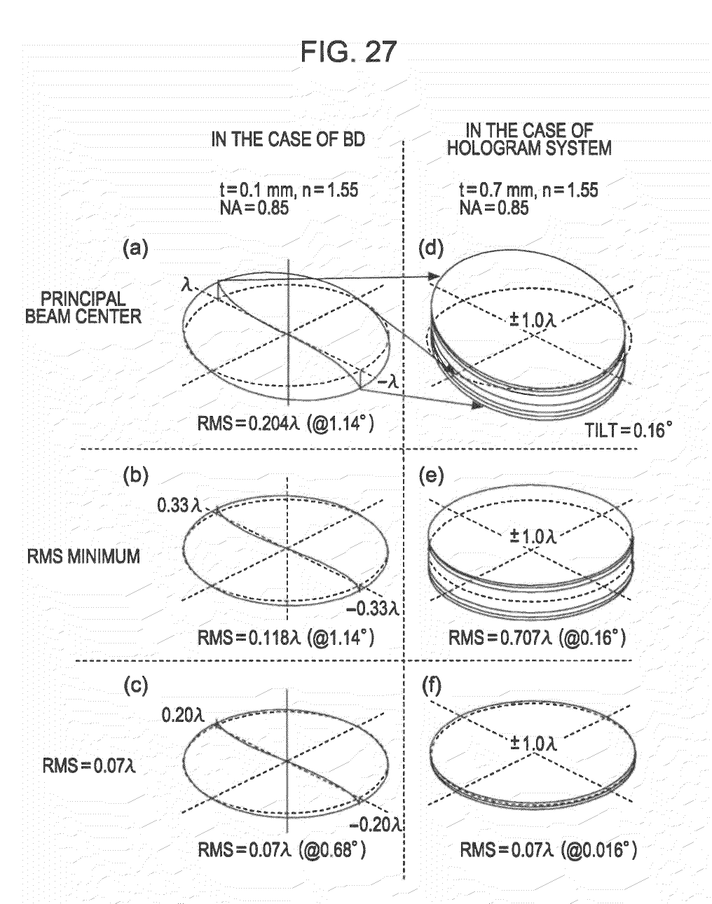

As already described with reference to FIGS. 26A and 26B, in an optical disc system, a coma aberration usually occurs due to occurrence of tilt. Particularly in the hologram recording/reproduction system which adopts the coaxial method, deterioration of a reproduction signal when a coma aberration occurs due to tilt is especially larger than that in the case of the current optical disc system because of the recording/reproduction principle, as already described with reference to FIG. 27. That is, the hologram recording/reproduction system based on the coaxial method has a problem that the tilt tolerance becomes very small compared with the past optical disc system.

Here, assuming that the numerical aperture of an objective lens which becomes an output end of laser light, which illuminates a recording medium, is NA and the distance from a surface of the recording medium to the focal position of the laser light is t, the amount of occurrence W of the coma aberration is expressed as W∝NA³·t. That is, the amount of occurrence W of the coma aberration can be suppressed by reducing NA of the objective lens or by reducing the value of the distance t from the recording medium surface to the focal position.

In view of this point, the applicant first proposes a method of suppressing the amount of occurrence W of the coma aberration, which is caused by tilt, by reducing the value of t.

Here, as described previously with reference to FIG. 23, the focal position of recording/reproduction light in the related art was on the reflection surface (upper-layer-side surface of the reflective layer L5: In other words, a lower-layer-side surface of the recording layer L4) of the reflective layer provided for the recording layer of a hologram. That is, the value of “t” is a distance from the top surface of the hologram recording medium 100 to the reflection surface of the reflective layer L5 and is a relatively large value including the thickness from the cover layer L1 to the recording layer L4. Accordingly, in the hologram recording/reproduction system as a past example, the amount of occurrence W of the coma aberration caused by tilt tends to be relatively large. This has been a main cause of narrowing the tilt tolerance.

In view of this point, in this example, the value of t is set to be smaller than that in the related art. That is, the value of t is set to be smaller than the “distance from the surface of the hologram recording medium 100 to the reflection surface of the reflective layer L3” in the related art. Specifically, the value of t is set to be significantly smaller than that in the related art by shifting the focal position of the laser light for recording/reproduction even near the surface of the hologram recording medium 100.

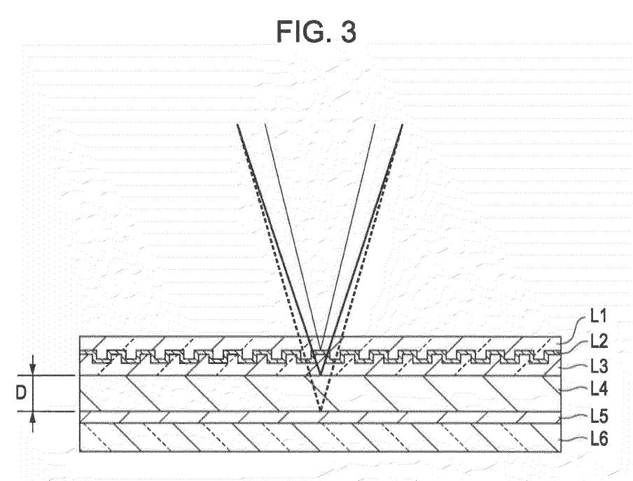

FIG. 3 is a diagram illustrating the focal position of laser light for recording/reproduction set in this example. FIG. 3 shows the sectional structure of the hologram recording medium 100 and also shows laser light for position control (thin solid line in the drawing) and laser light for recording/reproduction (thick solid line in the drawing), which illuminate the hologram recording medium 100, together. In addition, FIG. 3 shows laser light for recording/reproduction in the case of a past recording/reproduction system with a thick dotted line, for comparison.

As shown in FIG. 3, in this example, the focal position of the laser light for recording/reproduction is set on the interface between the substrate L3 and the recording layer L4. In other words, the focal position is set on the upper-layer-side surface of the recording layer L4.

In this case, the value of the distance t can be reduced by the thickness of the recording layer L4 expressed as “D” in the drawing.

Here, assuming that the cover thickness defined as a distance (that is, the thickness of the cover layer L1+reflective layer L2+substrate L3) from the recording medium surface to the recording layer L4 is 0.1 mm and the thickness of the recording layer L4 is 0.6 mm, the value of the distance t can be reduced to 0.1 mm in this example, while the value of the distance t is 0.7 mm in the past case where the focal position is on the reflection surface of the reflective layer L5.

Thus, by reducing the value of the distance t by shifting the focal position of the laser light for recording/reproduction to be closer to the recording medium surface than in the past, the amount of occurrence W of the coma aberration caused by tilt can be effectively suppressed. As a result, the tilt tolerance can be improved (increased) compared with that in the related art.

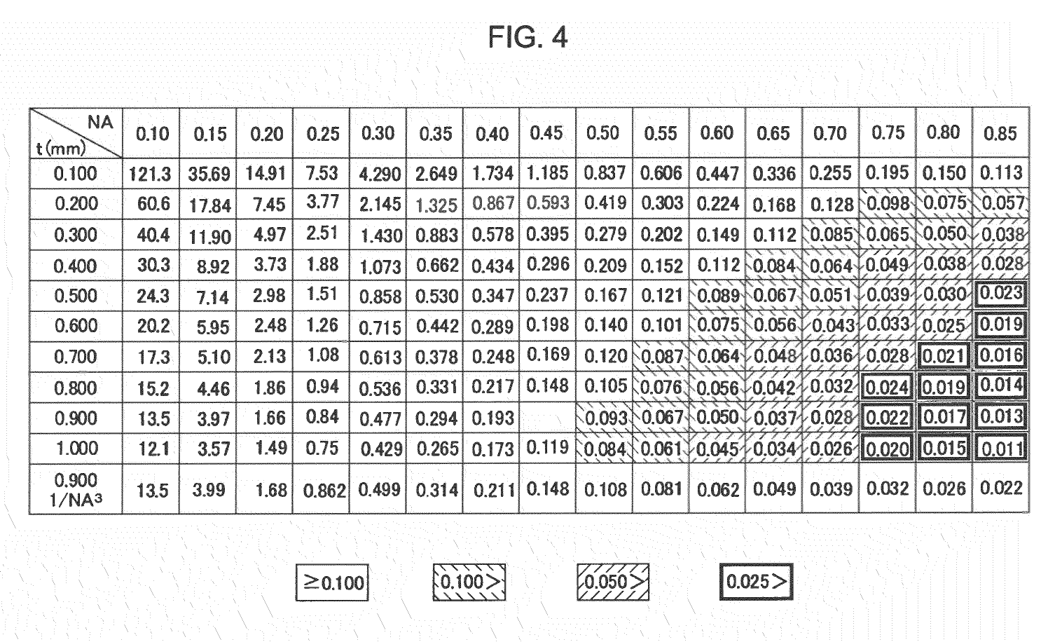

FIG. 4 shows a result after performing simulation regarding the relationship between set values of NA of the objective lens 11 and distance t and the reproduction tilt tolerance. In addition, in FIG. 4, the refractive index n of the hologram recording medium 100 is set to 1.55.

In addition, the tilt tolerance is expressed as a tilt angle which becomes Marechal criterion (λ=0.07).

In addition, although the tilt tolerance should be expressed using ±, ± is omitted in FIG. 4 for convenience of illustration.

As is apparent from the simulation result shown in FIG. 4, also in the hologram recording/reproduction system based on the coaxial method, NA and t largely affect the tilt tolerance (the amount of occurrence W of the coma aberration). In addition, FIG. 4 shows that the tilt tolerance increases (that is, the amount of occurrence W of the coma aberration is suppressed) as the value of NA increases and the value of t decreases and on the contrary, the tilt tolerance decreases (that is, the amount of occurrence W of the coma aberration increases) as the value of NA decreases and the value of t increases.

In addition, as described previously with reference to FIG. 27, NA=0.85 and t=0.7 mm in the past hologram recording/reproduction system. In FIG. 4, the tilt tolerance in this case is ±0.016°. On the other hand, in this example where t=0.1 mm, the tilt tolerance is ±0.113°. Therefore, according to the simulation result shown in FIG. 4, it can be seen that the tilt tolerance in this example is increased about seven times that in the related art.

Here, as is also apparent from the simulation result shown in FIG. 4 or the relational expression “W∝NA³·t” described previously, it may also be considered to adopt a method of reducing NA of the objective lens 11 in order to suppress the amount of occurrence W of the coma aberration. However, if NA is made small, the information recording/reproduction density is sacrificed. By adopting the method of reducing the value of t by adjustment of the focal position like this example, the tilt tolerance can be improved without reducing the information recording/reproduction density.

In addition, the most important point is that the method of shifting the focal position as described above is difficult to adopt in the past optical disc system. That is, when the focal position of the light for recording/reproduction is shifted in the past optical disc system, such as a DVD (Digital Versatile Disc) or a BD (Blu-ray Disc: registered trademark), it is naturally difficult to perform the data recording/reproduction appropriately. In the case of the hologram recording/reproduction system, however, a hologram can be appropriately recorded in the recording layer even if the focal position of the light for recording/reproduction is shifted and the hologram recorded as described above can be appropriately reproduced, due to the recording/reproduction principle. That is, in the present invention, a method of suppressing the coma aberration by shifting the focal position is adopted paying attention to the recording/reproduction principle which is unique to such a hologram recording/reproduction system.

(1-2-2. Specific Method for Focal Position Shift)

The above-described focal position shift of the laser light for recording/reproduction can be realized by making the distance between an objective lens and a hologram recording medium larger than that in the related art.

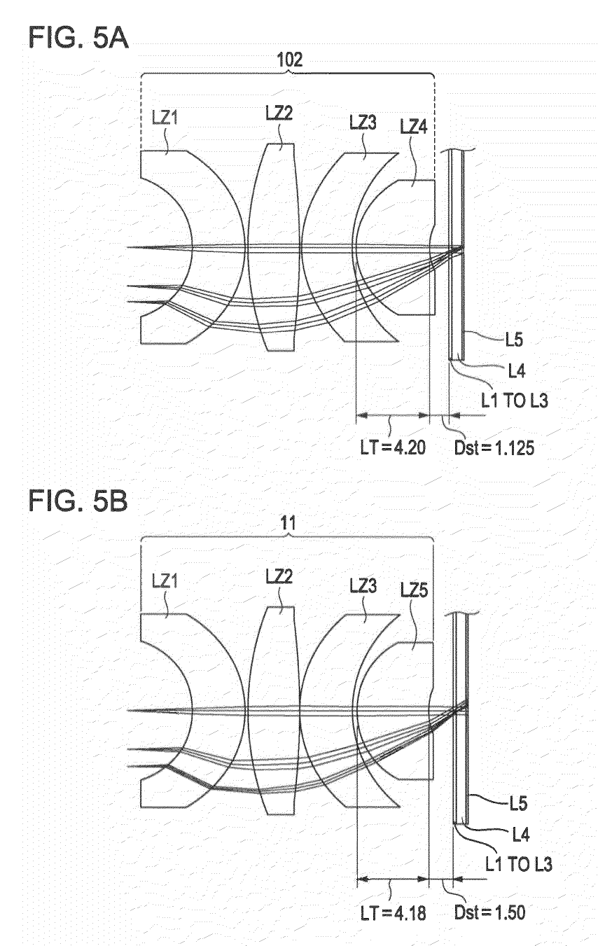

FIGS. 5A and 5B are diagrams illustrating examples of setting the distance between an objective lens and a hologram recording medium when changing the focal position of light for recording/reproduction. FIG. 5A shows an example in the past case where the objective lens 102 is used, FIG. 5B shows an example in this example where the objective lens 11 is used.

In each drawing, only the objective lens 102 in the past case and the objective lens 11 in this example, laser light for recording/reproduction which illuminates the hologram recording medium 100 through the objective lenses 102 and 11, and the cover layer L1 to substrate L3, recording layer L4, and reflective layer L5 of the hologram recording medium 100 are shown.

As shown in FIG. 5A, in the past case, the objective lens 102 includes a lens LZ1, a lens LZ2, a lens LZ3, and a lens LZ4 sequentially from the light source side. In this case, the thickness (LT in the drawing) of the lens LZ4 with the largest curvature is set to LT=4.20 mm.

In the past recording/reproduction apparatus, the focal position of the laser light for recording/reproduction is located on the reflective layer L5 by setting the distance LT from the emission surface of the objective lens 102 to the hologram recording medium 100 (top surface) to LT=1.125 mm as shown in the drawing using the objective lens 102.

On the other hand, in this example shown in FIG. 5B, the objective lens 11 includes a lens LZ1, a lens LZ2, and a lens LZ3 sequentially from the light source side similar to the objective lens 102 in the past case. However, for a lens with the largest curvature equivalent to the lens LZ4 in the objective lens 102, a lens LZ5 is used which has a thickness LT=4.18 mm that is a thickness reduced by 0.02 mm from the thickness LT=4.20 mm.

In this example, the reason why the thickness LT is reduced as described above is to suppress a spherical aberration occurring due to shifting the focal position.

Moreover, in this example, the distance Dst from the emission surface of the objective lens 11 to the hologram recording medium 100 is set to Dst=1.50 mm as shown in the drawing, which has been increased by about 0.375 mm from Dst=1.125 mm in the past case.

By the configuration of the objective lens 11 described above and setting of the distance Dst from the emission surface of the objective lens to the hologram recording medium 100, the focal position of the laser light for recording/reproduction which was on the reflective layer L5 in the past case can be shifted to the upper-layer-side surface (interface between the substrate L3 and the recording layer L4) of the recording layer L4. Specifically, the focal position of the laser light for recording/reproduction can be shifted by 0.6 mm toward the upper layer side.

Here, such adjustment of the distance Dst may be performed by adjusting the setting position of a medium holding section of a spindle motor which holds a hologram recording medium so as to be rotatable, for example. In the recording/reproduction apparatus of the present embodiment, the setting position of such a medium holding section is offset to the side becoming distant from the objective lens than in the past recording/reproduction apparatus. As a result, the focal position of the light for recording/reproduction is set at a position which is above the lower-layer-side surface of the recording layer as described above.

In addition, depending on a method of adjusting the distance Dst in this example, not only the focal position of the laser light for recording/reproduction is shifted, but also the focal position of the laser light for position control is also shifted similarly. As described previously with reference to FIG. 3, in this example, it is necessary to set the focal position of the laser light for position control on the reflective layer L2 in the same manner as in the related art. That is, in the case where the focal position of the laser light for recording/reproduction is set on the upper-layer-side surface of the recording layer L4 as in this example, it is necessary to set the distance between the focal position of the laser light for position control and the focal position of the laser light for recording/reproduction as a distance of “upper-layer-side surface of the recording layer L4—reflection surface of the reflective layer L2”.

In consideration of this point, in this example, the optical system is adjusted beforehand (for example, the position of the collimation lens 15 is adjusted) such that the distance between the focal position of the laser light for position control and the focal position of the laser light for recording/reproduction becomes the distance of “upper-layer-side surface of the recording layer L4—reflection surface of the reflective layer L2”, for example, by changing collimation when the laser light for position control is incident on the objective lens 11.

In addition, various methods of shifting the focal position of the light for recording/reproduction may be considered other than the method described above. For example, shifting of the focal position of the light for recording/reproduction may also be realized by design change of the objective lens 102. In the present invention, a specific method of shifting the focal position of the light for recording/reproduction is not particularly limited, and a method which is optimal for the actual embodiment or the like may be appropriately adopted.

(1-2-3. Change in a Behavior of Light According to Focal Position Shift)

Here, in the case where the focal position of the light for recording/reproduction is shifted from the reflection surface of the reflective layer L5 as described above, the behavior of light becomes naturally different from that in the related art.

˜Change of a Hologram Recorded˜

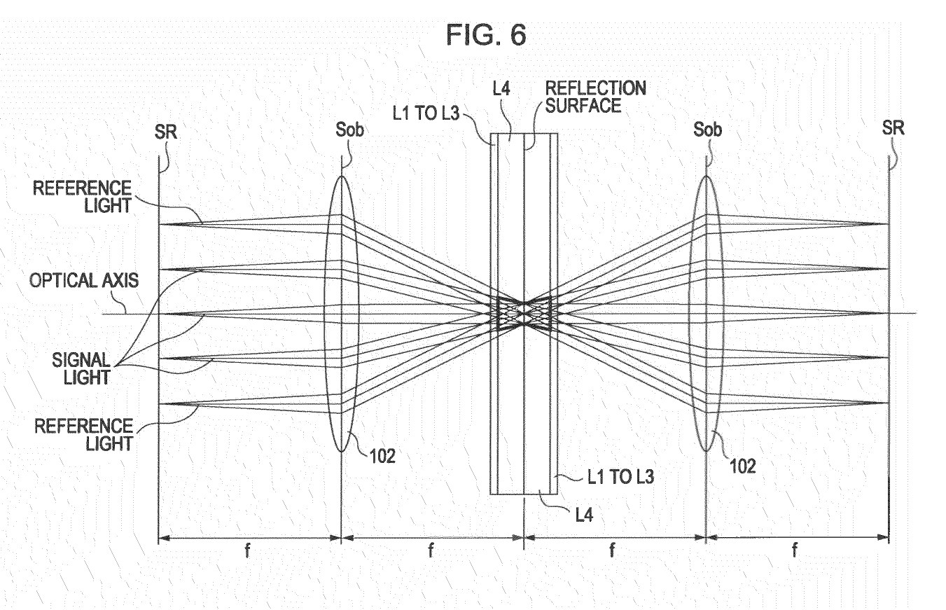

The shape of a hologram recorded in the recording layer L4 becomes different from that in the related art due to shifting the focal position. This point will be described with reference to FIGS. 6 to 9.

Here, matters common to FIGS. 6 to 9 will be described.

Each drawing of FIGS. 6 to 9 shows only the objective lens 11 (objective lens 102 in FIG. 6) and the cover layer L1 to substrate L3, recording layer L4, and reflection surface of reflective layer L5 in the hologram recording medium 100 and also shows the situation of recording/reproduction light which illuminates the hologram recording medium 100.

As is apparent from the previous explanation using FIG. 1, in practice, light (=return path light) reflected from the reflection surface of the reflective layer L5 returns to the side on which the forward path light is incident. In FIGS. 6 to 9, however, not only the return path light but also the recording layer L4, the substrate L3 to the cover layer L1, and the objective lens 11 or 102 are shown to be folded back to the opposite side to the side, on which the forward path light is incident, with the reflection surface as the border, for convenience of illustration.

In addition, a plane SR in FIGS. 6 to 9 indicates an actual image surface (object surface for the objective lens) of the SLM 4 formed by the relay lens system 6 and 7. In addition, a plane Sob in the drawing indicates a pupil surface of the objective lens 11 (in FIG. 6, the objective lens 102).

Moreover, in FIGS. 6 to 9, regarding the signal light, only light beams for a total of three pixels are shown which are a light beam for one pixel in the middle matched with the laser optical axis among pixels in the signal light area A2 and light beams for the other two pixels. In addition, regarding the reference light, only light beams corresponding to two pixels positioned at the outermost peripheral portions within the reference light area A1 are shown.

First, the shape of a hologram formed in the hologram recording medium 100 by the past recording/reproduction system will be described with reference to FIG. 6.

In the past case, the focal position of the light for recording/reproduction is set on the reflection surface. Accordingly, in the past recording/reproduction apparatus, the focal distance f of the objective lens 102 becomes a distance from the pupil surface Sob of the objective lens to the reflection surface.

In this case, each light beam of the signal light and each light beam of the reference light are condensed at one point on the reflection surface as shown in the drawing.

In this case, the light beams (light beams for every pixel) of the signal light and reference light are once condensed on the actual image surface SR as shown in the drawing and are then incident on the objective lens 102 in a state of diffused light. Then, the light beams which have been incident on the objective lens 102 are condensed at one point on the reflection surface of the hologram recording medium 100 in a state of parallel light.

In the past case where the focal position of the light for recording/reproduction is on the reflection surface, the optical path length of return path light is equal to that of forward path light. Accordingly, each of the forward path light and the return path light has a symmetrical shape with the reflection surface as a central axis. As a result, a hologram formed in the recording layer L4 is also formed in a symmetrical shape with the reflection surface as a central axis as surrounded by a thick frame in the drawing.

In addition, for clarity, a hologram is formed by interference between signal light and reference light. Accordingly, a hologram is formed in a portion where the signal light and the reference light overlap each other in the recording layer L4. In the coaxial method, the signal light and the reference light illuminate a recording medium so as to be converged at one point (in this case, on the reflection surface). Accordingly, the shape of the hologram formed in this case becomes an hourglass shape as shown in the drawing.

Moreover, in FIG. 6, since the reflected light which returns to the forward path light side originally is shown to be folded back to the opposite side, the shape of a hologram is shown as the approximately hourglass shape described above. In practice, however, a hologram (trapezoidal shape) in the right half in the drawing is formed to overlap a hologram in the left half in the drawing.

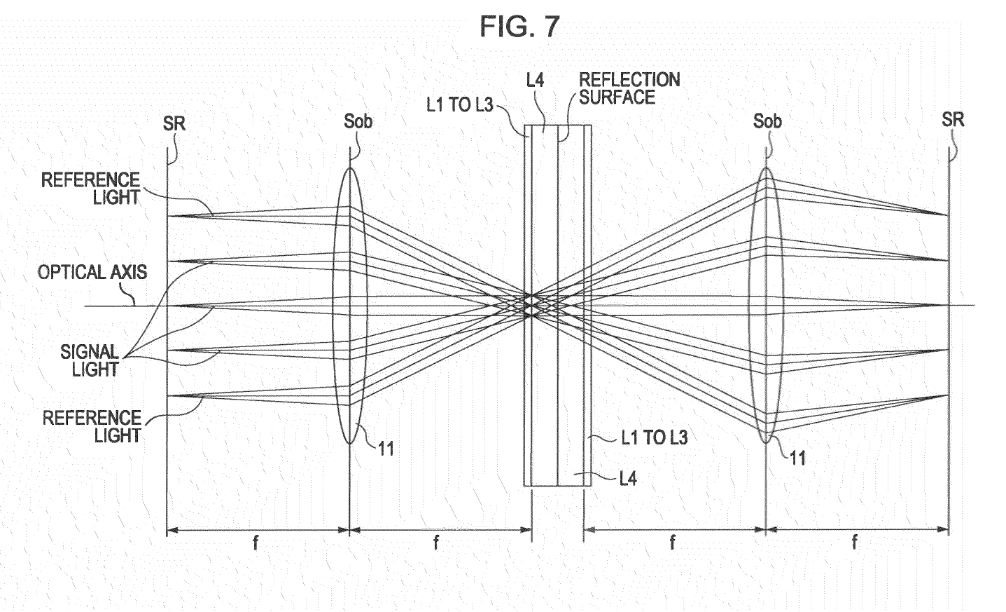

FIG. 7 shows the situation of signal light and reference light, which illuminate the hologram recording medium 100, and return path light thereof in this example where the focal position of the light for recording/reproduction is on the upper-layer-side surface of the recording layer L4.

First, when the focal position is on the upper-layer-side surface of the recording layer L4, the focal distance f of the objective lens 11 becomes a distance from the pupil surface Sob to the upper-layer-side surface of the recording layer L4 as is also apparent from the drawing.

Moreover, in this case, signal light and reference light as diffused light after condensing illuminate the recording layer L4 as shown in the drawing.

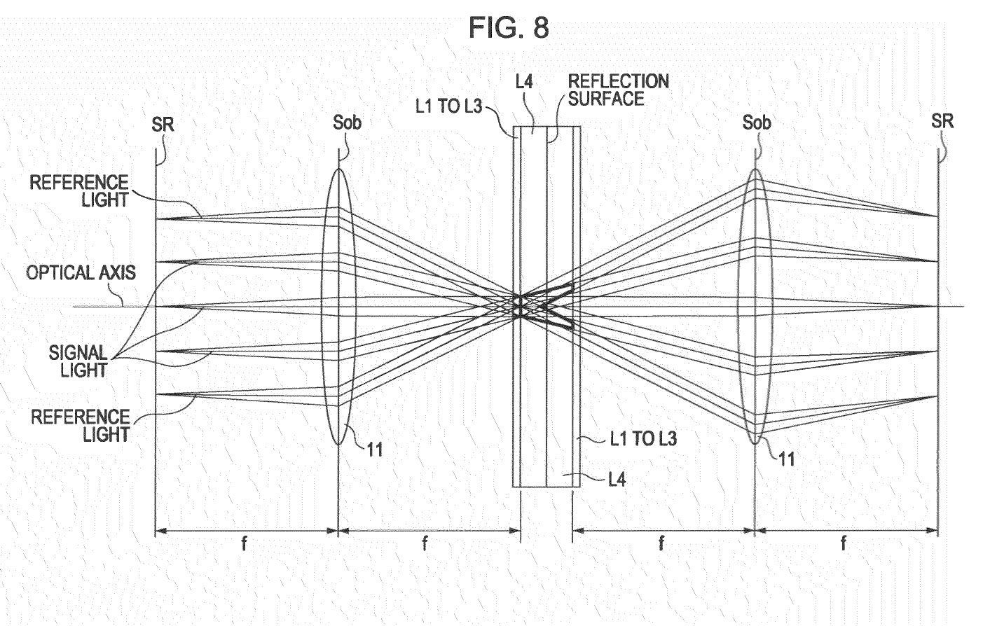

Accordingly, the shape of a hologram formed in the recording layer L4 in this case becomes a shape shown as a thick frame in FIG. 8.

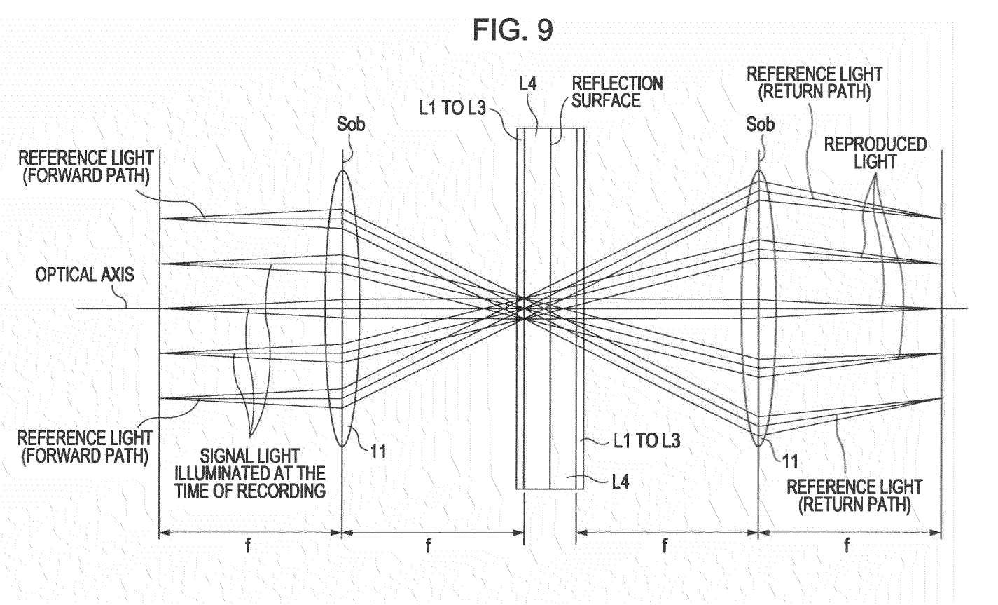

FIG. 9 shows the situation where the hologram recorded as described above is reproduced.

As also can be understood from the explanation up to now, if the reference light illuminates the hologram formed in the recording layer L4, reproduced light (reproduced image) of the recorded signal light is output by diffraction phenomenon. FIG. 9 shows reference light (forward path) illuminated at the time of reproduction, reproduced light obtained by illumination of the reference light, and reference light (reflected reference light: return path reference light) reflected from the reflection surface. In addition, FIG. 9 also shows the locus of the signal light illuminated at the time of recording.

˜Change of Light Position of Return Path Light˜

Here, as is apparent from comparison between FIG. 6 and FIGS. 7 to 9, positional deviation of forward path light and return path light occurs in this example where the focal position is shifted from the reflection surface.

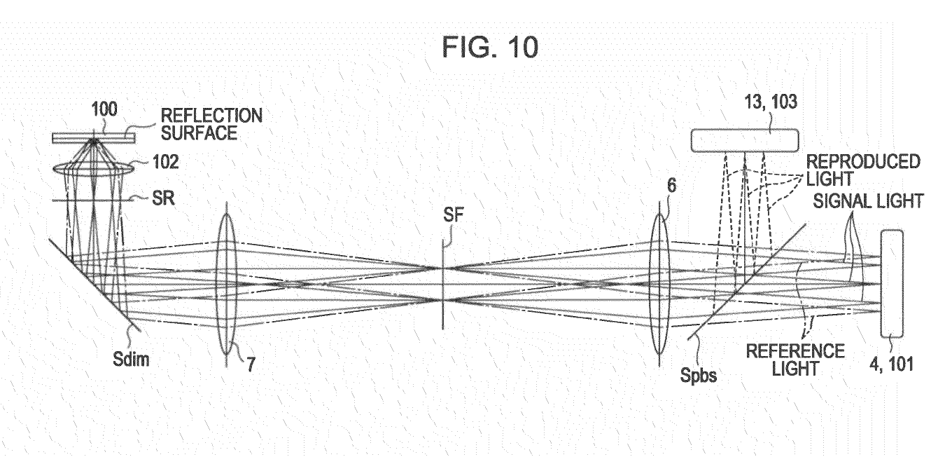

Referring to FIGS. 10 to 12, the behavior of light in the entire optical system will be checked in the past case and in this example.

In addition, also in FIGS. 10 to 12, only light beams for three pixels are representatively shown for the signal light and only light beams for two pixels are representatively shown for the reference light.

Moreover, in FIGS. 10 to 12, only the SLM 4, the relay lenses 6 and 7, and the objective lens 11 or 102 of the configuration of the entire optical system are shown. In addition, FIGS. 10 to 12 also show the hologram recording medium 100. In addition, a plane Spbs in each drawing indicates a reflection surface of the polarization beam splitter 5, and a plane Sdim indicates a reflection surface of the dichroic mirror 8.

FIG. 10 shows the behavior of light in the past case. In addition, since the position through which each light beam passes is equal in the forward path and the return path in the past case, the drawing is common.

As shown in the drawing, a light beam emitted from each pixel of the SLM 4 is incident on the relay lens 6 through the plane Spbs (polarization beam splitter 5) in a state of diffused light. In this case, optical axes of the emitted light beams from pixels are parallel.

The light beams of the pixels incident on the relay lens 6 are converted from diffused light into parallel light as shown in the drawing, and the optical axis of each light beam excluding light beams on the laser optical axis (optical axis of the whole laser light flux) is folded to the laser optical axis side. Accordingly, on the plane SF, the light beams are condensed on the laser optical axis in a state of parallel light. Here, the plane SF is a plane on which light beams of pixels, which are parallel light, are condensed on the laser optical axis similar to the focal surface using the objective lens and is called a Fourier plane (frequency plane).

The light beams condensed on the laser optical axis on the Fourier plane SF as described above are incident on the relay lens 7. In this case, however, the light beams (excluding the light beam of the pixel in the middle including the laser optical axis) emitted from the relay lens 6 cross the laser optical axis on the Fourier plane SF. Accordingly, the relationship of incidence and emission positions of each light beam in the relay lens 6 and the relay lens 7 becomes axisymmetric with the laser optical axis as the center.

The light beams are converted into convergent light through the relay lens 7 as shown in the drawing, and the optical axes of the light beam become parallel. Each light beam transmitted through the relay lens 7 is reflected on the plane Sdim (dichroic mirror 8) and is then condensed at each position on the actual image surface SR shown in FIG. 9. In this case, the light beams transmitted through the relay lens 7 become light beams the optical axes of which are parallel as described above. Accordingly, on the actual image surface SR, the condensing positions of the light beams do not overlap but become different positions.

In addition, the behavior of light after the actual image surface SR is the same as that described previously in FIG. 6.

Here, FIG. 10 shows reproduced light which is reflected on the plane Spbs and is then guided to the image sensor 13 (103). The reason why only the reproduced light is guided to the image sensor 13 as shown in the drawing is because reflected reference light is suppressed by the partial diffraction element 9 (and the ¼ wavelength plate 10) described previously.

In addition, for clarity, the partial diffraction element 9 is provided on the actual image surface SR or its neighborhood. This is because it is necessary for the partial diffraction element 9 to selectively transmit/diffract light in a region of signal light and a region of reference light as also described above. If the partial diffraction element 9 is not disposed at the position where the same image as the SLM 4 (image generated surface) is obtained, it is difficult to realize a selective transmission/diffraction operation appropriately.

In addition, at the time of reproduction, the reproduced light is obtained at the same beam position as the signal light illuminated at the time of recording. That is, the reproduced light arrives at the plane Spbs following the same position as the signal light in the drawing and is then reflected on this plane Spbs and guided to the image sensor 13. In this case, the reproduced light beams emitted from the relay lens 6 toward the plane Spbs are convergent light and the optical axes of the reproduced light beams are parallel. Accordingly, the light beams are condensed at different positions on the detection surface of the image sensor 13. As a result, the same image as the reproduced image on the actual image surface SR is obtained on the detection surface of the image sensor 13.

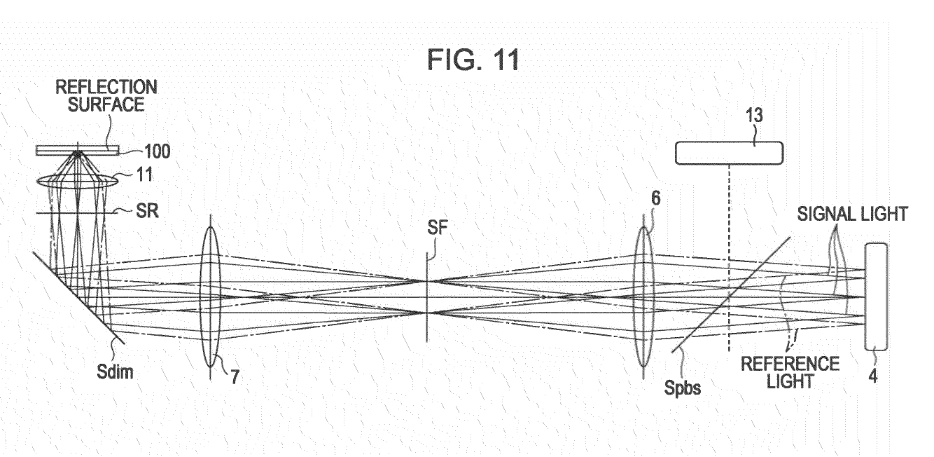

FIG. 11 shows the behavior of light in this example and the behavior of forward path light at the time of recording.

In this case, the behavior of light from the SLM 4 to the objective lens 11 is the same as usual. The different point from the related art is that the focal position (that is, the condensing position of each of the signal light and the reference light transmitted through the objective lens 11 in the drawing) of the light for recording/reproduction is not on the reflection surface of the reflective layer L5 but is shifted to the interface between the substrate L3 and the recording layer L4, as described previously in FIG. 7.

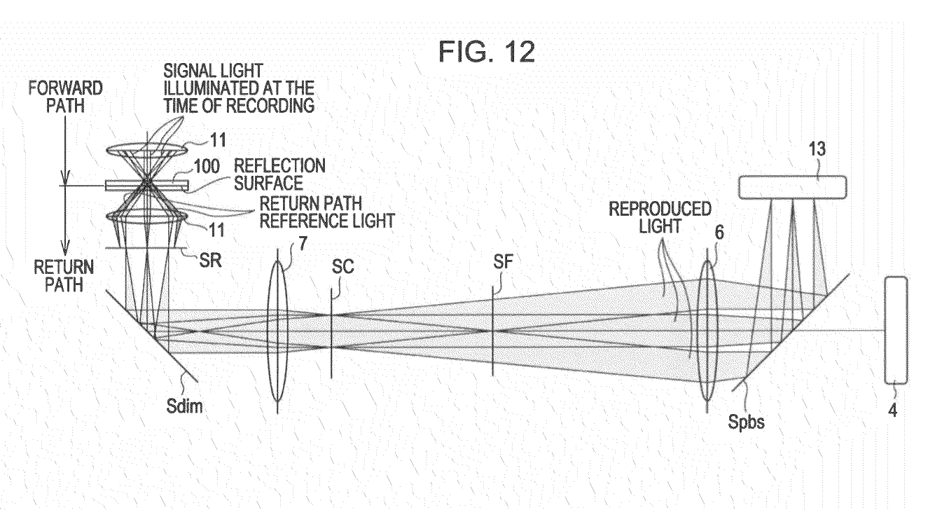

FIG. 12 shows the behavior of return path light at the time of reproduction in this example.

Moreover, in FIG. 12, both forward path light beams of reference light as forward path light, which illuminates the hologram recording medium 100 through the objective lens 11 at the time of reproduction, and signal light (light beam with no color) illuminated at the time of recording are shown to be folded back to the opposite side with the reflection surface of the hologram recording medium 100 as the border.

As also shown in FIGS. 7 to 9, in this example where the focal position is shifted from the reflection surface to the upper layer side, the incidence position of each light beam (excluding a light beam of a pixel in the middle including the laser optical axis) on the pupil surface Sob of the objective lens 11 changes between the forward path light and the return path light. Specifically, the incidence position of the return path light is shifted more to the outer side than the incidence position of the forward path light. Thus, in this example, the position of the return path light shown in FIG. 12 is different from the position of the forward path light shown in FIG. 11.

In addition, since the incidence position of the forward path light on the pupil surface Sob of the objective lens 11 is different from the incidence position of the return path light on the pupil surface Sob of the objective lens 11 as described above, the incidence position of each light beam on the pupil surface of the relay lens 7 or the pupil surface of the relay lens 6 changes between the forward path light and the return path light. Accordingly, the position of a condensing surface of each light beam formed by the relay lens system using the relay lenses 6 and 7 also changes between the forward path light and the return path light.

Specifically, if the incidence position of the return path light on the pupil surface Sob is shifted to the outer side, the incidence position of the return path light on the pupil surface of the relay lens 7 is shifted to the inner side than the incidence position of the forward path light. Accordingly, the condensing surface (referred to as a return path conjugate surface SC) of the return path light is shifted to the condensing surface of the forward path light, that is, to a position closer to the relay lens 7 than is the Fourier plane SF.

Here, it should be noted that the condensing position of each light beam on the actual image surface SR (the same on the detection surface of the image sensor 13) is the same as that shown in FIG. 10 or 11. That is, since the condensing position of each light beam on the actual image surface SR is equal, a reproduced image can be appropriately detected by the image sensor 13 at the time of reproduction, similar to the related art.

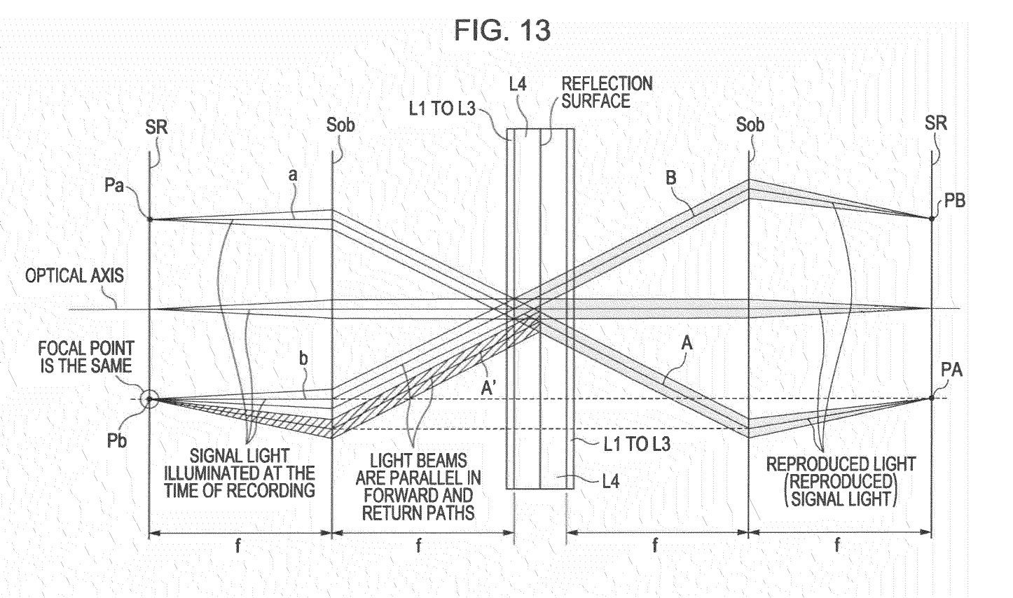

Here, referring to FIG. 13, the reason why the position of the forward path light and the position of the return path light on the actual image surface SR are equal as described above will be described.

Moreover, similar to FIGS. 7 to 9, FIG. 13 shows the actual image surface SR, the pupil surface Sob of the objective lens 11, and the cover layer L1 to substrate L3, recording layer L4, and reflection surface of reflective layer L5 in the hologram recording medium 100 and also shows the reproduced light output from the hologram recording medium 100 at the time of reproduction. Regarding the reproduction light, a total of three light beams are representatively shown which are a light beam for one pixel in the middle and light beams for two pixels located at the outermost peripheral portions. In addition, FIG. 13 shows signal light (light beams with no color in the drawing: only light beams for a total of three pixels, which are a light beam for one pixel in the middle and light beams for two pixels located at the outermost peripheral portions, are shown) illuminated as forward path light at the time of recording. In addition, similar to FIGS. 7 to 9, not only the return path light (in this case, reproduced light) but also the cover layer L1 to the recording layer L4 are shown to be folded back to the opposite side with the reflection surface as the border.

Here, regarding the signal light illuminated at the time of recording, it is assumed that a light beam located at the uppermost portion in the drawing is a and a light beam located at the lowermost portion is b. In addition, regarding the reproduced light, it is assumed that a light beam located at the uppermost portion is B and a light beam located at the lowermost portion is A.

In addition, on the actual image surface SR, the condensing position (focal position) of the light beam a among the signal light beams is set as Pa, and the condensing position of the light beam b is set as Pb. Similarly, the condensing position of the light beam A among the reproduced light beams on the actual image surface SR is set as PA, and the condensing position of the light beam B is set as PB.

Moreover, in FIG. 13, a light beam A′ in the drawing is shown without folding of the light beam A among the reproduced light beams. Here, the light beam A is light parallel to the light beam a. In addition, in the coaxial method, the light beam a and the light beam b illuminate the hologram recording medium 100 at the same incidence angle with respect to the optical axis. Accordingly, the light beam A′ becomes light parallel to the light beam b.

Here, by the feature of the objective lens (convex lens), when two light beams which are parallel as described above have been transmitted through the objective lens 11, the condensing positions of the two light beams are equal on the focal plane (here, the actual image surface SR) which is distant by the focal distance f. Accordingly, the condensing position Pb of the light beam b on the actual image surface SR and the condensing position PA of the light beam A on the actual image surface SR become equal.

Naturally, such a relationship is also satisfied for the light beam a and the light beam B. Accordingly, the condensing position Pa of the light beam a on the actual image surface SR is equal to the condensing position PB of the light beam B on the actual image surface SR.

By such a principle, even if the focal position of the light for recording/reproduction is shifted from the reflection surface, the condensing position of each return path light beam and the condensing position of each forward path light beam become equal on the actual image surface SR.

This explanation continues referring back to FIG. 12.

As described above, the matching between the condensing position of each return path light beam and the condensing position of each forward path light beam on the actual image surface SR means that the condensing position of each light beam on the actual image surface SR is the same as in the past case.

Accordingly, a reproduced image acquired on the actual image surface SR at the time of reproduction is the same as that in the past case (that is, when the focal position is on the reflection surface), such that an appropriate reproduced image can also be detected as usual in the image sensor 13. That is, since a problem, such as shift or blurring of a reproduced image, due to mismatching between the positions of forward path light and return path light caused by shift of the focal position does not occur, data reproduction can be appropriately performed.

Moreover, as can be understood from the above explanation, also in the case where the method of shifting the focal position is adopted, the configuration of an optical system for guiding the light for recording/reproduction to the hologram recording medium 100 and guiding the reproduced light, which has been acquired from the hologram recording medium 100, to the image sensor 13 is the same as the configuration in the past case except for the objective lens 11. Therefore, the configuration does not have to be changed.

[1-3. Simulation Result]

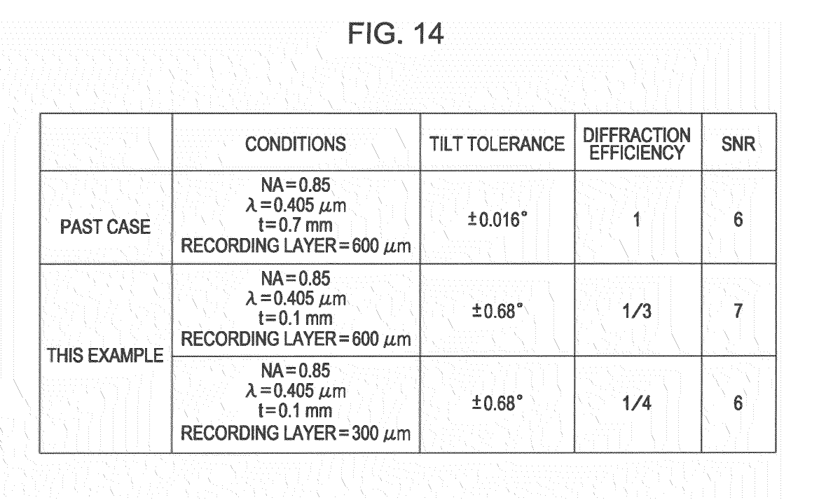

FIG. 14 shows a simulation result for each item of tilt tolerance, diffraction efficiency, and SNR (S/N ratio) when the focal position shift in this example has been performed.

In FIG. 14, not only the simulation result for each item of tilt tolerance, diffraction efficiency, and SNR (S/N ratio) when the focal position shift in this example has been performed is shown, but also a simulation result for each item in the past method in which the focal position is on the reflection surface is shown for comparison.

Regarding the method of this example, results in both a case where the thickness of a recording layer is set to 600 μm and a case where the thickness of a recording layer is set to 300 μm, which is the half of 600 μm, are shown in FIG. 14. As the specific conditions set for this simulation, NA of an objective lens and the wavelength λ of light for recording/reproduction were set as NA=0.85 and λ=0.405 μm, which are the same in both the past case and the case of this example.

In the past case, the cover thickness (cover layer L1 to the thickness of the substrate L3) is 0.1 mm, and the thickness of the recording layer L4 is 0.6 mm, and t is 0.7 mm. On the other hand, in this example, the cover thickness is 0.1 mm which is the same as that in the past case, but t is 0.1 mm by shifting the focal position to the interface between the substrate L3 and the recording layer L4.

First, the tilt tolerance in the past case was “±0.016°”, while the tilt tolerance in this example was “±0.68°” in both the cases where the thickness of the recording layer L4 was 600 μm and 300 μm. Therefore, a result was obtained in which the tolerance was improved about 40 times compared with that in the past case.

In addition, assuming that the diffraction efficiency in the past case was “1”, the diffraction efficiency when the thickness of the recording layer L4 was 600 μm was “⅓” and the diffraction efficiency when the thickness of the recording layer L4 was 300 μm was “¼”.

Here, the reason why the diffraction efficiency in this example tends to be lower than that in past case is because formed holograms are different as previously compared in FIGS. 6 and 7. For example, as can be seen from FIG. 6, in the past case, the region where the signal light and the reference light overlap each other in the recording layer L4 is relatively large. In this example, however, the region where the signal light and the reference light overlap each other is relatively small as shown in FIG. 7 or 8, for example. Particularly in a return path portion after the reflection surface, the degree of overlapping between the signal light and the reference light is low. This is a cause of lowering the diffraction efficiency.

In addition, the reason why the diffraction efficiency is lowered in response to reducing the thickness of the recording layer L4 is because the thickness of a hologram is also reduced as the recording layer L4 becomes thin.

However, in the comparison of SNR, this example has the same or higher performance than the past case. Specifically, the SNR is “7” in this example where the thickness of the recording layer L4 is 600 μm, while the SNR is “6” in the past case. Also when the thickness of the recording layer L4 is 300 μm, the SNR is “6”. Accordingly, the same value as in the past case is obtained.

Here, in the past case, the signal light and the reference light are condensed on the reflection surface as shown in FIG. 6. In addition, the light beams condensed on the reflection surface as described above return through the same light beam region as the forward path. That is, in the past case, in the recording layer L2, the same hologram is formed in the forward path and the return path. The depths of these holograms are equal in a portion up to 0 to 600 μm in the example of this case.

On the other hand, in this example where the focal position is on the upper-layer-side surface of the recording layer L2, the signal light and the reference light continuously spread in the forward path→return path in the recording layer L2 as can be seen from FIG. 7 and the like. Accordingly, the depth of a recorded hologram can be more extended than that in the past case (comparison of FIGS. 6 and 8). Specifically, in the case where the thickness of the recording layer L2 is set to 600 μm, a hologram having a depth of 0 to 1200 μm can be recorded. In addition, in the case where the thickness of the recording layer L2 is set to 300 μm, a hologram having a depth of 0 to 600 μm can be recorded.

In this case, the high frequency information is carried in a portion distant from the focal position in the hologram formed in the recording layer. Accordingly, when compared in the same condition where the thickness of the recording layer L2 is 600 μm, the information with a higher frequency can be recorded in this example where a deeper hologram can be formed (that is, a hologram can be formed in a portion which is further away from the focal position). In addition, when the thickness of the recording layer L2 is 300 μm, the high frequency information can be recorded similar to the past case.

The more the high frequency information can be recorded, the clearer the reproduced image can be. For this reason, if the condition of the recording layer thickness is the same, the SNR in this example is improved compared with the SNR in the past case. In addition, even if the recording layer thickness in this example is half of that in the past case, the SNR can be equal to that in the past case.

[1-4. Conclusion of Effects of the Past Example]

As described above, according to the recording/reproduction system as a past example, the amount of occurrence W of the coma aberration caused by tilt can be suppressed by shifting the focal position of the light for recording/reproduction such that the value of t defined as a “distance from the recording medium surface to the focal position of the light for recording/reproduction” is smaller than in the past case.

As a result, the tilt tolerance can be improved.

In addition, in the past example, a method of reducing the value of NA is not adopted to suppress the amount of occurrence W of the coma aberration caused by tilt. Accordingly, the tilt tolerance can be improved without sacrificing the information recording/reproduction density.

In addition, in the past example, the focal position of the light for recording/reproduction is on the interface (upper-layer-side surface of the recording layer L4) between the substrate L3 and the recording layer L4. Accordingly, a portion with a high light intensity where the signal light and the reference light are narrowest can be formed in the recording layer L4. This is advantageous in terms of diffraction efficiency.

In addition, according to the simulation result shown in FIG. 14, the SNR in the past example where the thickness of the recording layer L4 is 300 μm is the same as that in the past case. That is, by the focal position shift as the past example, the lowering of the reproduction performance can be suppressed even if the thickness of the recording layer L4 is set to be smaller than that in the past case (in this case, half).

As also can be understood from this, according to the method as in the past example, the thickness of the recording layer L4 can be set to be smaller than that in the past case (according to the simulation result, the thickness of the recording layer L4 can be made small up to half of that in the past case). If the thickness of the recording layer L4 can be made small, manufacturing costs of a recording medium can be reduced.

<2. Hologram Recording/Reproduction System as an Embodiment>

[2-1. Problems in the Past Example]

According to the method of focal position shift as the past example described above, the tilt tolerance can be significantly improved compared with that in the related art.

However, in the case of adopting such a method as a past example, a useless exposed portion is generated in the recording layer L4 by a change in the light state caused by shifting of the focal position to the upper layer side. Thus, media (recording material) tend to be unnecessarily consumed.

Here, when the focal position is shifted to the more upper layer side than in the past case as shown in FIG. 7 or 8, a portion, in which the signal light and the reference light overlap each other so that effective information recording is performed, in the recording layer L4 almost concentrates on the forward path section before reflection on the reflection surface. As a result, in most of the return path section after the reflection, only some signal light beams overlap the reference light. That is, the return path section after the reflection becomes a useless exposed portion.

The useless exposed portion is a portion where media (recording material) is consumed even though effective information recording is not performed. When multiple recording of a hologram is performed, the useless exposed portion lowers the S/N (S/N ratio). That is, as also can be understood from this point, such a useless exposed portion is a cause of reducing the recording density of a hologram.

[2-2. Hologram Recording Medium as an Embodiment]

When the method of focal position shift as in the past example is adopted, the recording density tends to be reduced compared with that in the past case because the above-described useless exposed portion is generated in the recording layer L4.

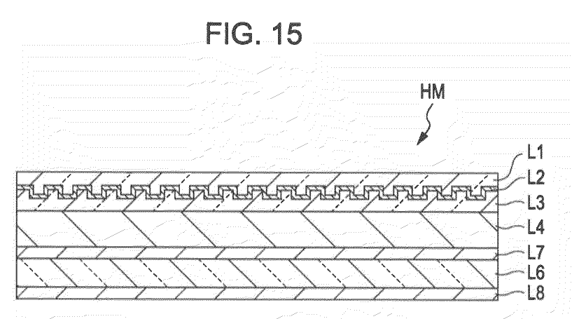

Therefore, in the present embodiment, in order to suppress the reduction in the recording density caused by such useless exposure, a hologram recording medium HM shown in FIG. 15 is used instead of the past hologram recording medium 100.

Moreover, as described above, the configuration of the recording/reproduction apparatus according to the present embodiment is the same as that in the past example. Accordingly, an explanation about the configuration of the recording/reproduction apparatus according to the present embodiment will be omitted.

As shown in FIG. 15, the hologram recording medium HM in the present embodiment is different from the hologram recording medium 100 in the past case in that the reflective layer L5 has been changed to an angle-selective reflective layer L7. In addition, an absorption layer L8 is formed below the substrate L6.

The angle-selective reflective layer L7 is a reflective layer which has a selective light reflection/transmission characteristic depending on the light incidence angle. In this case, the angle-selective reflective layer L7 which has a characteristic of selectively transmitting the light, which is incident at a predetermined angle or more, is used. Using such a characteristic, signal light or reproduced light which is disposed at the inner side and the incidence angle of which is small can be reflected and reference light which is disposed at the outer side and the incidence angle of which is large can be transmitted in the coaxial method.

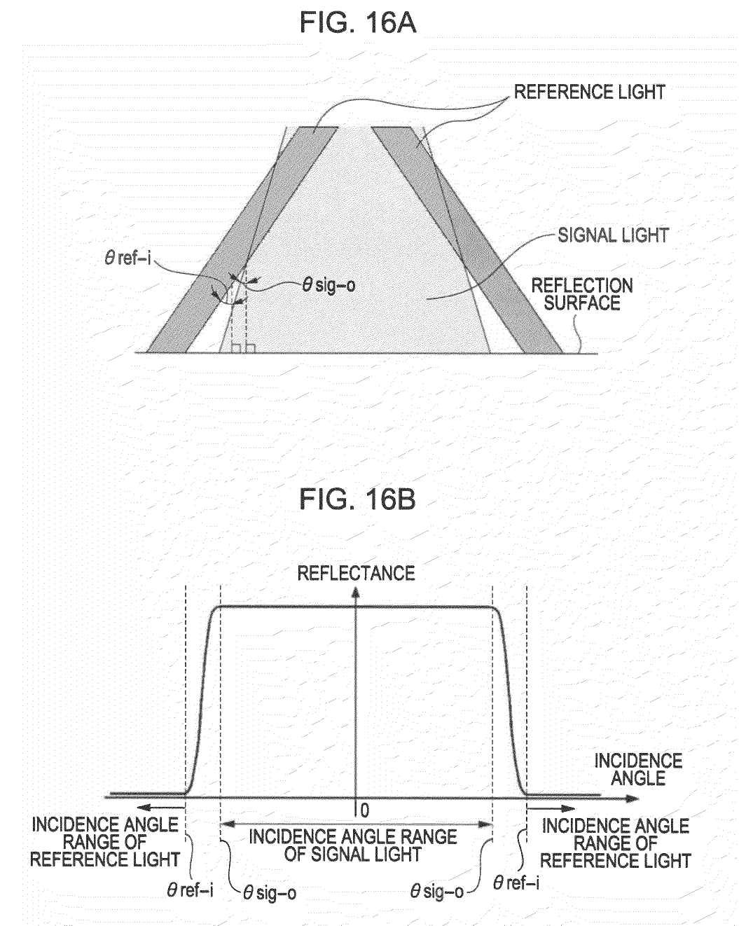

FIGS. 16A and 16B are diagrams illustrating the specific characteristic of the angle-selective reflective layer L7. FIG. 16A shows the situation where the signal light and the reference light are incident on the reflection surface (upper-layer-side surface of the angle-selective reflective layer L7) of the hologram recording medium HM, and FIG. 16B shows the light reflection/transmission characteristic of the angle-selective reflective layer L7 assuming that the horizontal axis indicates the light incidence angle and the vertical axis indicates the reflectance.

Here, regarding the incidence angle of light with respect to the reflection surface in FIG. 16A, the incidence angle of a signal light beam positioned at the outermost peripheral portion is set as θsig-o and the incidence angle of a reference light beam positioned at the innermost peripheral portion is set as θref-i.

As shown in FIG. 16B, the angle-selective reflective layer L7 has a characteristic of reflecting the light the incidence angle of which is equal to or smaller than θsig-o and transmitting the light the incidence angle of which is larger than θsig-o. Specifically, for the reflectance in a region where the incidence angle is equal to or smaller than θsig-o, a maximum value (for example, almost “1”) is maintained. In addition, the reflectance abruptly drops when the incidence angle becomes larger than θsig-o and transitions in a state of low reflectance (ideally, transitions in almost “0”) when the incidence angle reaches a certain incidence angle.

FIG. 16B shows the case where the incidence angle when the reflectance has reached a minimum value after the abrupt drop is θref-i.

Thus, since the angle-selective reflective layer L7 is used which has a characteristic of reflecting the light the incidence angle of which is equal to or smaller than θsig-o and transmitting the light the incidence angle of which is larger than θsig-o, the reference light is transmitted through the angle-selective reflective layer L7. On the other hand, light (especially the reproduced light at the time of reproduction) in a light beam region of the signal light is reflected by the angle-selective reflective layer L7 and returns to the apparatus side as usual.

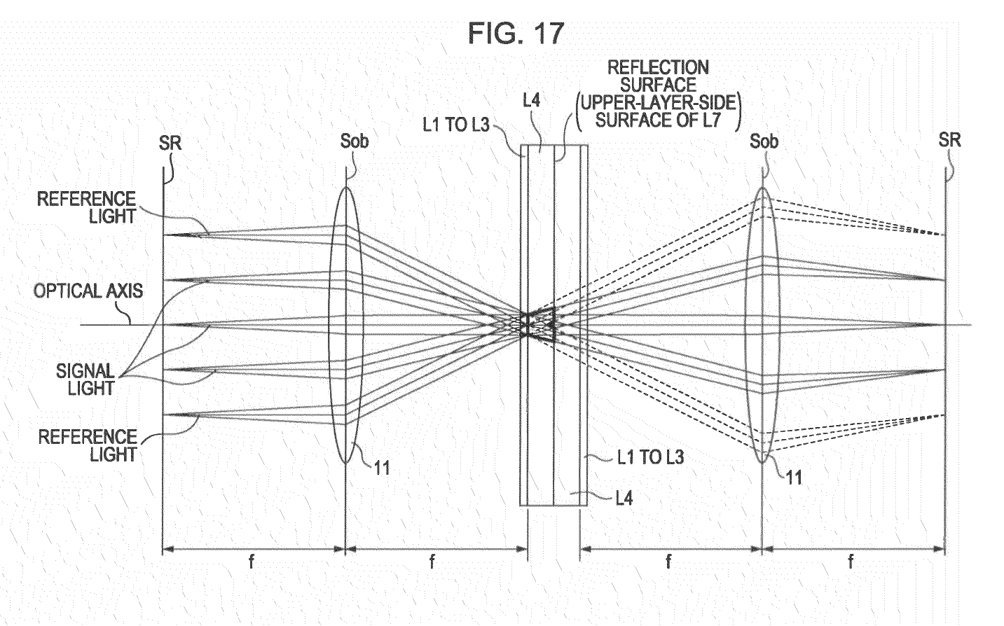

FIG. 17 is a diagram illustrating a hologram formed in the recording layer L4 in the present embodiment in which the hologram recording medium HM formed with the angle-selective reflective layer L7 is used.

Similar to FIG. 7, FIG. 17 also shows only the objective lens 11, the cover layer L1 to the substrate L3, the recording layer L4, and the reflection surface (in this case, a reflection surface of the angle-selective reflective layer L7) and also shows the situation of each of the signal light and the reference light. Moreover, also in FIG. 17, not only the return path light but also the recording layer L4, the substrate L3 to the cover layer L1, and objective lens 11 are shown to be folded back to the opposite side to the side, on which the forward path light is incident, with the reflection surface as the border.

As described above, in this case, since the reference light is transmitted through the angle-selective reflective layer L7, the reflected reference light is significantly suppressed in the recording layer L4. Accordingly, media consumption at the return path side is significantly suppressed. That is, useless exposure is significantly suppressed. For example, if the reflectance of the reference light is “0”, a hologram is not formed in the return path. Accordingly, a hologram formed in this case has a shape shown by a thick frame in the drawing.

Thus, since the reflected reference light is suppressed and the useless exposure in the return path is significantly suppressed, a drop in the S/N ratio resulting from the useless exposure can be significantly suppressed in the case of performing multiplex recording of a hologram. As a result, a reduction in the recording density can be suppressed.

In addition, if the reflected reference light can be significantly suppressed as described above, scattering light generated by illumination of the reference light at the time of reproduction can also be significantly suppressed. If the scattering light can be suppressed, the S/N ratio can be improved.

Here, in the hologram recording medium HM of the embodiment, the absorption layer L8 is provided below the substrate L6 as shown in FIG. 15. The absorption layer L8 is a light absorption layer configured to absorb the incident light. Through such an absorption layer L8, it is possible to absorb the reference light which has been selectively transmitted by the angle-selective reflective layer L7.

[2-3. Specific Example of the Layer Structure]

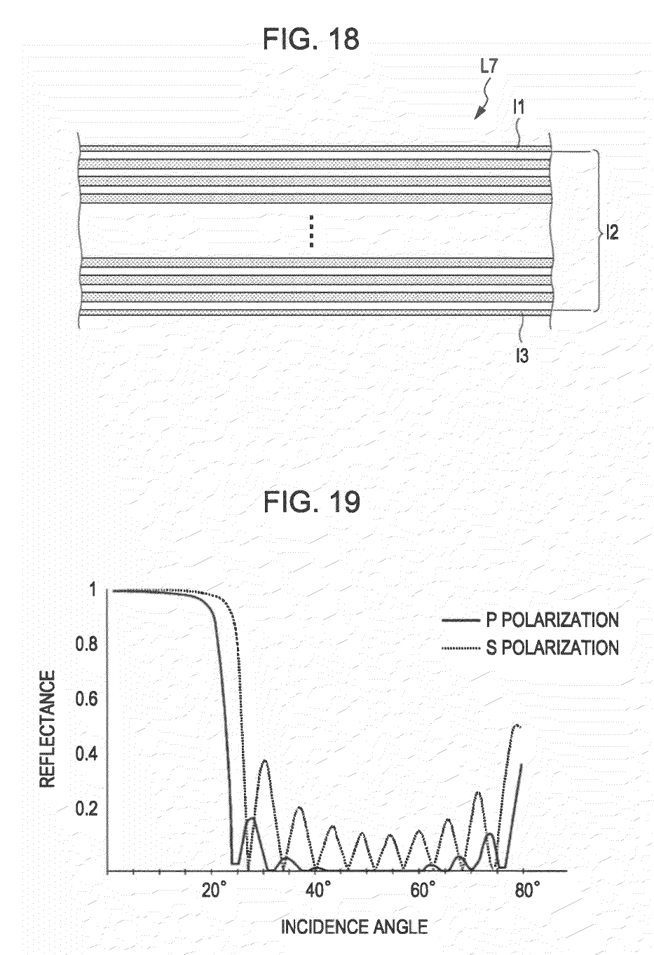

FIG. 18 shows a specific structure example of the angle-selective reflective layer L7.

As shown in FIG. 18, the angle-selective reflective layer L7 may be realized as a multilayer structure. Specifically, the angle-selective reflective layer L7 may be realized as a multilayer structure where an SiO₂ layer (colored layer in the drawing) and an Al₂O₃ layer are alternately laminated.

In the example shown in FIG. 18, the SiO₂ layer is disposed as an uppermost layer 11 and a lowermost layer 13 in the multilayer structure as the angle-selective reflective layer L7. Then, in an intermediate portion 12 between the uppermost layer 11 and the lowermost layer 13, the Al₂O₃ layer and the SiO₂ layer are alternately laminated such that the Al₂O₃ layer is disposed immediately below the uppermost layer 11 and immediately above the lowermost layer 13.

In this case, the thickness of each layer in the intermediate portion 12 is set to ¼ of the wavelength λ of the light for recording/reproduction. In addition, the thickness of the SiO₂ layer in the uppermost layer 11 and the lowermost layer 13 is set to ½ of the thickness of each layer in the intermediate portion 12, that is, λ/8.

In addition, in the intermediate portion 12, the number of Al₂O₃ layers is 16, the number of SiO₂ layers is 15, and the total number of layers in the entire multilayer structure is 33. In addition, the refractive index of the Al₂O₃ layer is 1.76, and the refractive index of the SiO₂ layer is 1.45.

FIG. 19 shows the characteristic of the angle-selective reflective layer L7 when it is formed as the multilayer structure described in FIG. 18. Moreover, in the drawing, the characteristic shown by a solid line is a characteristic for p-polarized light, and the characteristic shown by a dotted line is a characteristic for s-polarized light. Also in this drawing, the horizontal axis indicates the incidence angle and the vertical axis indicates the reflectance.

From the characteristic shown in FIG. 19, the angle-selective reflective layer L7 with the structure described in FIG. 18 can selectively transmit most light beams the incidence angle of which is approximately 27° or more.

Here, the incidence angle θsig-o of the signal light beam positioned at the outermost peripheral portion and the incidence angle θref-i of the reference light beam positioned at the innermost peripheral portion, which are shown in FIG. 16A, are determined by the radius (referred to as “rs”) of the signal light area A2 of the SLM 4, the radius (referred to as “rr-i”) of the reference light area A1 up to the innermost periphery, the radius (referred to as “rr-o”) of the reference light area A1 up to the outermost periphery, NA of the objective lens 11, and the refractive index (refractive indices of the cover layer L1 to recording layer L4) n of a recording medium.

For example, regarding the sizes of signal light and reference light, rs=2.3 mm, rr-i=2.8 mm, rr-o=3.2 mm, and n=1.5 are set.

In this case, assuming that NA is 0.85, the focal distance f of the objective lens 11 is 3.765 mm (rr-o/NA). Accordingly, the incidence angle is θsig-o=24.0° and θref-i=29.7°.

The angle-selective reflective layer L7 with the multilayer structure shown in FIG. 18 can appropriately allow the reference light to be selectively transmitted therethrough when such conditions are set in the recording/reproduction apparatus side.

Moreover, according to the calculation when the above values of rs, rr-i, rr-o, and n are set, assuming that NA is 0.75, the focal distance f is 4.267 mm, the incidence angle θsig-o is 25.9°, and the incidence angle θref-i is 21.1°.

In addition, assuming that NA is 0.65, the focal distance f is 4.923 mm, the incidence angle θsig-o is 22.3°, and the incidence angle θref-i is 18.1°.

The angle-selective reflective layer L7 is preferably formed to have a characteristic of selectively transmitting only the reference light according to NA or the size of the signal light and reference light set in the apparatus side as described above and the values of the incidence angles θsig-o and θref-i determined by the refractive index n. Specifically, it is preferable that the angle-selective reflective layer L7 has a characteristic that the region shown in FIG. 16B or 19, in which the reflectance abruptly drops, is located between the incidence angle θsig-o and the incidence angle θref-i.

For example, in the case of the multilayer structure shown in FIG. 18, the angle of the boundary of reflection/transmission may be adjusted by setting of a material (refractive index), which forms each layer, or the thickness of each layer. In addition, the falling angle (reduction rate of the reflectance with respect to the incidence angle in a portion where the reflectance abruptly drops in FIG. 16B or 19) of the reflectance may be adjusted by the number of laminated layers.

In addition, for clarity, the structure shown in FIG. 18 is only an example and it is a matter of course that the angle-selective reflective layer L7 may also be realized by other structures.

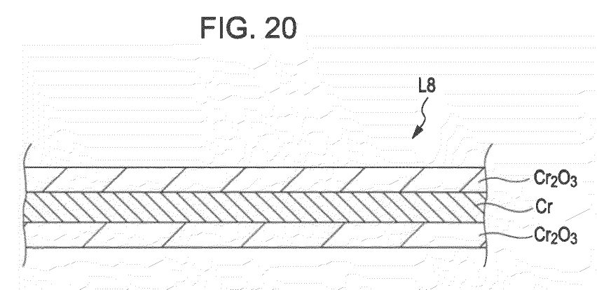

FIG. 20 shows a specific structure example of the absorption layer L8 shown in FIG. 15.

As shown in FIG. 20, the absorption layer L8 may be realized by a structure in which a Cr layer is interposed between Cr₂O₃ layers, for example.

According to the present embodiment described above, in the case where the method of focal position shift as a past example is adopted, the hologram recording medium HM is used in which the angle-selective reflective layer L7 is formed below the recording layer L4. Accordingly, since the reflected reference light which illuminates the recording layer L4 can be suppressed by the angle-selective reflective layer L7, useless exposure to the recording layer L4 can be effectively suppressed. As a result, the recording density can be improved.

In addition, since the reflected reference light can be suppressed as described above, scattering light generated by illumination of the reference light at the time of reproduction can also be suppressed. As a result, the S/N ratio can be improved. Here, the recording density can be improved by the improvement in the S/N ratio. Therefore, according to the present embodiment, the recording density can also be improved in terms of suppression of such scattering light.

Moreover, in the present embodiment, since the absorption layer L8 is provided, leakage of light transmitted through the angle-selective reflective layer L7 to the outside of a recording medium can be prevented. As a result, it is possible to prevent the leakage light from having an adverse effect on recording/reproduction of a hologram.

<3. Modifications>

While each embodiment of the present invention has been described, the present invention is not limited to the specific examples described up to now.

For example, the above explanation is based on the premise that the focal position of the light for recording/reproduction is set within the range from the surface of the hologram recording medium HM to the reflection surface of the reflective layer L3. However, according to the relational expression “W∝NA³·t” for the amount of occurrence W of the coma aberration, it is needless to say that the focal position can be set at a position (that is, a position at which the value of t is negative) which is at the objective lens 11 side rather than the recording medium surface in order to suppress the coma aberration caused by tilt.

In addition, from the above relational expression, it is also needless to say that t=0 is best in terms of suppression of the coma aberration.

In any case, in the present invention, the coma aberration caused by tilt can be better suppressed than in the related art by making the distance |t| between the recording medium surface and the focal position of light for recording/reproduction smaller than the distance (that is, the distance between the surface and the focal position in the related art) between the recording medium surface and the lower-layer-side surface of the recording layer. As a result, the tilt tolerance can be improved.

In addition, the structure of the hologram recording medium HM is not limited to that shown in FIG. 15.

For example, a recording layer related to the position control information may be provided below the recording layer L4 of a hologram. Specifically, the pair of reflective layer L2 and substrate L3 shown in FIG. 15 may be formed below the angle-selective reflective layer L7. In this case, since the substrate L6 is formed below the substrate L3, the substrate L6 may be removed.

For example, when such a structure is adopted, most light for position control is reflected by the angle-selective reflective layer L7. However, for example, if some light beams in the outer peripheral portion are made to pass through the angle-selective reflective layer L7, the light for position control reaches the reflective layer L2. Accordingly, light which reflects the position control information can be obtained. In addition, for clarity, when such a structure is adopted, it is not necessary for the reflective layer L2 to have the wavelength selectivity.

In any case, in the present invention, the angle-selective reflective layer is provided below the recording layer of a hologram. Accordingly, since it is possible to selectively transmit the reference light by the angle-selective reflective layer, useless exposure can be suppressed. In addition, by reflecting light in the light beam region of the signal light, it is possible to make the reproduced light return to the apparatus side appropriately at the time of reproduction.

Moreover, in the explanation up to now, in order to avoid complication of the explanation, the spatial light phase modulation has been performed on the signal light and the reference light. However, in order to improve the recording/reproduction performance, a random phase pattern, such as a binary random phase pattern (random phase pattern including the same number of “π” and “0”), may be given to the signal light and the reference light at the time of recording and the reference light at the time of reproduction. Such giving of a phase pattern may be realized, for example, by providing an optical element called a phase mask which performs phase modulation by giving the optical path length difference at the time of incidence using the uneven sectional shape.

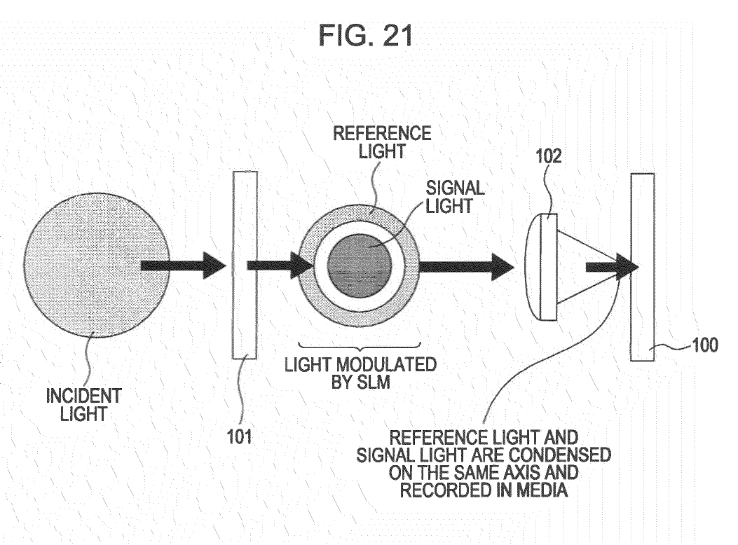

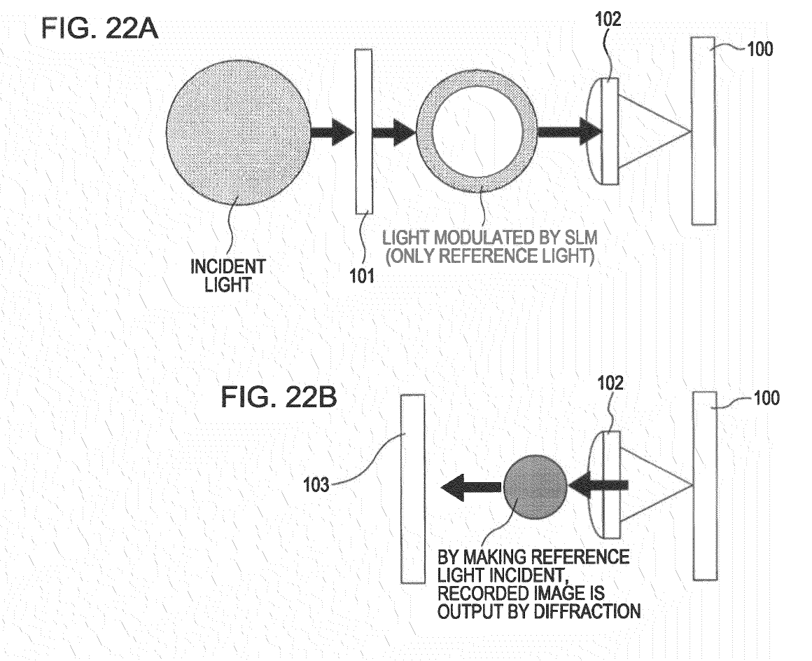

Moreover, in the explanation up to now, the case has been illustrated in which intensity modulation for generating the signal light and the reference light generation is realized by the combination of the polarization direction control type spatial light modulator and the polarization beam splitter. However, the configuration for realizing the intensity modulation is not limited thereto. For example, the intensity modulation may be realized using a spatial light modulator capable of performing the intensity modulation by itself, such as a DMD (Digital Micromirror Device: registered trademark) or the SLM 101 using a transmissive liquid crystal panel described in FIG. 21 or FIGS. 22A and 22B.

The present application contains subject matter related to that disclosed in Japanese Priority Patent Application JP 2009-007845 filed in the Japan Patent Office on Jan. 16, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A recording/reproduction method of performing recording/reproduction of a hologram by illuminating a hologram recording medium, which has a recording layer in which information is recorded by interference fringes between signal light and reference light, with the signal light and/or the reference light as recording/reproduction light through an objective lens, comprising the step of:
setting a focal position of the recording/reproduction light such that a distance from a surface of the hologram recording medium to the focal position of the recording/reproduction light is larger than a distance from the surface to a lower-layer-side surface of the recording layer and illuminating the hologram recording medium including an angle-selective reflective layer, which is formed below the recording layer and has a selective light reflection/transmission characteristic depending on a light incidence angle, with the recording/reproduction light the focal position of which has been set.

2. A hologram recording medium comprising:
a recording layer in which information is recorded by interference fringes between signal light and reference light; and
an angle-selective reflective layer which is formed below the recording layer and has a selective light reflection/transmission characteristic depending on a light incidence angle.

3. The hologram recording medium according to claim 2,
wherein the angle-selective reflective layer is configured to transmit light which is incident at a predetermined incidence angle or more.

4. The hologram recording medium according to claim 2,
wherein the angle-selective reflective layer is formed as a multilayer structure.

5. The hologram recording medium according to claim 2, further comprising:
a light absorption layer formed below the angle-selective reflective layer.
